(19) United States
(12) Patent Application Publication
(10) Pub. No.: US 2010/0070362 A1
(43) Pub. Date: Mar. 18, 2010

(54) BOOMTIME SERVICE PROVISIONING SYSTEMS AND METHODS

(76) Inventor: William F. Bice, Sandia Park, NM (US)

Correspondence Address: Richard H. Krukar;Attorney, Intellectual Property, Ortiz & Lopez, PLLC, P.O. Box 4484, Albuquerque, NM, 87196-4484, US

(21) Appl. No.: 12/543,616

(22) Filed: Aug. 19, 2009

Related U.S. Application Data
(63) Continuation of application No. 11/708,879, filed on Feb. 20, 2007.

(51) Int. Cl. G06Q 30/00; G06Q 10/00

(52) U.S. Cl. 705/14.26; 705/14.39

(57) ABSTRACT

A facilitator supports numerous organizations that supply personal services by providing infrastructure and a management interface for controlling and customizing the infrastructure. The infrastructure includes databases, a web site, scheduling tools, and sales tools. The sales tools can offer both personal services and goods, such as shampoo or lotion. The personal services can be purchased for direct use by the purchaser or as a gift to a recipient. The recipient can receive a gift certificate electronically, through the mail, or delivered by hand. A traveling client can select an organization far from home based on proximity or availability.

### CROSS REFERENCE TO RELATED APPLICATIONS

This patent application is a continuation of U.S. patent application Ser. No. 11/708,879 filed on Feb. 20, 2007 entitled “BoomTime Services” and which is incorporated herein by reference in its entirety.

### TECHNICAL FIELD

Embodiments relate to the fields of personal services related businesses, web browsers, client/server computer architectures. Embodiments also relate to web based layout tools, web page design, design templates, databases, and internet based commerce.

### BACKGROUND

Many small personal services related businesses, such as health spas, use ad hoc methods for handling their operations. For example, point of sale systems are not tied in any way to scheduling. Furthermore those businesses that do use computer based solutions use lowest common denominator solutions. An example of a lowest common denominator solution is a health spa in Oregon using the same solution as a golf pro shop in Florida. Both businesses have an adequate solution, but neither has a good one.

Web site design tools have existed for almost as long as the web itself. Some tools provide systems and methods for building an Internet store. For example, Cafe Press offers systems and methods for creating an Internet t-shirt store. Designs can be entered, and web pages for presenting designs and taking orders are provided. The back end databases for supporting the t-shirt store are also provided, as are systems for payment, t-shirt production, and shipping. Customers, however, associate the transaction with Cafe Press because the materials are branded as such.

In some aggregation schemes the gift certificate is redeemed, or cashed in, at the aggregator and some of the proceeds are then passed to the affiliate. In other aggregation schemes, the gift certificate is redeemed at the affiliate. The affiliate then presents the gift certificate to the aggregator at which time the aggregator pays the associate. In either case, the aggregator holds the money used to buy all the certificates that have been sold and not yet redeemed. The aggregator makes a particularly healthy profit from gift certificates that are never redeemed.

Web site design tools have existed for almost as long as the web itself. Some tools provide systems and methods for building Internet stores. For example, Cafe Press offers systems and methods for creating an Internet t-shirt store. Designs can be entered. Also, web pages for presenting designs and taking orders are provided. The back end databases for supporting the t-shirt store are also provided, as are systems for payment, t-shirt production, and shipping. Customers, however, associate the transaction with Cafe Press because the materials are branded as such.

Many businesses use preprinted gift certificate forms in order to immediately receive the gift certificate revenue, but they usually can not track outstanding certificates or sell electronic gift certificates over the Internet. An electronic gift certificate is a gift certificate that a customer can purchase over the Internet and then print out.

Other businesses use an aggregator to provide gift certificates. The gift certificates have terms and conditions that are designed to simultaneously comply with every one of the anticipated legal jurisdictions of the businesses and their customers. As such, they loose advantages provided by local or state statutes.

Systems and methods are needed to supply business with solutions for gift certificates, aggregation, and sensitivity to legal jurisdictions that overcome limitations in the currently available solutions.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

Limitations in current technology can be addressed by providing systems and methods for producing and/or publishing Internet content such as web pages and web sites that organizations can use for producing gift certificates, managing customers, and managing professionals. The legal aspects of the web site are automatically customized based on the organization's jurisdiction, on a customer's jurisdiction, or on a combination of jurisdictions. The organizations can customize the internet content to reflect branding or look and feel.

It is therefore an aspect of the embodiments that a client computer is connected to a communications network. A server is also connected to the communications network. The client computer uses a display device to present information to a user. The user uses at least one input device, such as a keyboard or mouse, to provide an input to the client computer.

It is an aspect of some embodiments to provide a management interface. The management interface can have a number of different management pages. Some of the management pages provide a web site design interface. The web site design interface can include templates that the user can select such that the user initiates web site or web page creation by selecting a template and then modifying the template to obtain a more personalized result. A web browser running on the client computer can obtain the various pages of the management interface from the server.

It is another aspect of some embodiments to provide access to the management interface to an organization. The personnel of the organization, such as a personal services related business, can use the management interface to manage an organization web site and the services provided by way of the organization web site. Initially, the organization web site is based on a default web site, perhaps using the templates discussed above. The organization can use the web site design interface to edit, modify, and customize the organization web site.

It is a further aspect of some embodiments to host the organization web site. Hosting a web site means making the web site available on the Internet.

It is a yet further aspect of some embodiments to provide a customer database and a services database. The customer database contains information about the organization's individual customers. The services database contains information about the services provided by the organization to the customers.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a first organization, a second organization, and a third organization all using the same aggregated information systems provider in accordance with aspects of certain embodiments;

FIG. 2 illustrates a high level block diagram of a system that automatically notifies clients of upcoming events and produces event based modifications to a web site in accordance with aspects of certain embodiments;

FIG. 3 illustrates interactions involving a jurisdiction module in accordance with aspects of certain embodiments;

FIG. 4 illustrates a client seeking services in an emergency in accordance with aspects of certain embodiments;

FIG. 5 illustrates obtaining performance metrics in accordance with aspects of certain embodiments;

FIG. 6 illustrates the “Today” page of the SpaBoom website in accordance with aspects of the embodiments;

FIG. 7 illustrates a GC, or gift certificate, summary page in accordance with aspects of the embodiments;

FIG. 8 illustrates an “Add GC” page used for adding in a new gift certificate in accordance with aspects of the embodiments;

FIG. 9 illustrates a page for adding a new client in accordance with aspects of the embodiments;

FIG. 10 illustrates an Appointments page containing an appointments table in accordance with aspects of the embodiments;

FIG. 11 illustrates a “Clients” page in accordance with aspects of the embodiments;

FIG. 12 illustrates an “Add Client” page in accordance with aspects of the embodiments;

FIG. 13 illustrates a main “Reports” page that presents a Reports menu in the left side bar in accordance with aspects of the embodiments;

FIG. 14 illustrates a “Client Detail” page in accordance with aspects of the embodiments;

FIG. 15 illustrates a “Client Journal” page in accordance with aspects of the embodiments;

FIG. 16 illustrates a “Balances” page in accordance with aspects of the embodiments;

FIG. 17 illustrates a “Cash Flow” page in accordance with aspects of the embodiments;

FIG. 18 illustrates a “Report: Billing History” page in accordance with aspects of the embodiments;

FIG. 19 illustrates a main “Setup” page in accordance with aspects of the embodiments;

FIG. 20 illustrates a “Client Types” page in accordance with aspects of the embodiments;

FIG. 21 illustrates an “Events” page in accordance with aspects of the embodiments;

FIG. 22 illustrates a “GC Designs” page in accordance with aspects of certain embodiments;

FIG. 23 illustrates an “Edit GC Design” in accordance with aspects of certain embodiments;

FIG. 24 illustrates an “Edit GC Category” page in accordance with aspects of certain embodiments;

FIG. 25 illustrates a “GC Types” page in accordance with aspects of certain embodiments;

FIG. 26 illustrates an “Edit GC Type” page in accordance with aspects of certain embodiments;

FIG. 27 illustrates a “Pages” page in accordance with aspects of the embodiments;

FIG. 28 illustrates a “Page” page in accordance with aspects of the embodiments;

FIG. 29 illustrates a Header page in accordance with aspects of the embodiments;

FIG. 30 illustrates a “Professionals” page in accordance with aspects of the embodiments;

FIG. 31 illustrates an “Edit Professional” page in accordance with aspects of the embodiments;

FIG. 32 illustrates a “Services” page in accordance with aspects of the embodiments;

FIG. 33 illustrates an “Edit Service Category” page in accordance with aspects of the embodiments;

FIG. 34 illustrates a “Service” page in accordance with aspects of the embodiments;

FIG. 35 illustrates an “Edit Service” page in accordance with aspects of the embodiments;

FIG. 36 illustrates an “Add Service Category” page in accordance with aspects of the embodiments;

FIG. 37 illustrates an “Add Service” page in accordance with aspects of the embodiments;

FIG. 38 illustrates an “Add Package” page in accordance with aspects of the embodiments;

FIG. 39 illustrates a “Basics” page in accordance with aspects of the embodiments;

FIG. 40 illustrates a “Billing” page in accordance with aspects of the embodiments;

FIG. 41 illustrates an “Hours” page in accordance with aspects of the embodiments;

FIG. 42 illustrates a “Logo” page in accordance with aspects of the embodiments;

FIG. 43 illustrates a “Website” page in accordance with aspects of the embodiments;

FIG. 44 illustrates the home page for a personal services vendor in accordance with aspects of the embodiments;

FIG. 45 illustrates the services page of a personal services vendor's website in accordance with aspects of the embodiments;

FIG. 46 also illustrates the services page of a personal services vendor's website in accordance with aspects of the embodiments;

FIG. 47 illustrates the “Request Appointment” first page of a personal services vendor's website in accordance with aspects of the embodiments;

FIG. 48 illustrates the “Request Appointment” client information page of a personal services vendor's website in accordance with aspects of the embodiments;

FIG. 49 illustrates the “Instant Gift Certificate” first page of a personal services vendor's website in accordance with aspects of certain embodiments;

FIG. 50 illustrates the “Instant Gift Certificate” first page of a personal services vendor's website wherein the “Service” radio button is selected in accordance with aspects of certain embodiments;

FIG. 51 illustrates an “Instant Gift Certificate” in accordance with aspects of certain embodiments;

FIG. 52 illustrates a gift certificate service provider in accordance with aspects of certain embodiments;

FIG. 53 illustrates a high level flow diagram of setting up an organization in accordance with aspects of the embodiments;

FIG. 54 illustrates a high level block diagram of providing an instant gift certificate ordering capability to an organization in accordance with aspects of certain embodiments;

FIG. 55 illustrates a high level block diagram of receiving customer information from an organization and providing an instant gift certificate in accordance with aspects of certain embodiments;

FIG. 56 illustrates a high level block diagram of receiving a gift certificate request and responding with gift certificate data in accordance with aspects of certain embodiments;

FIG. 57 illustrates high level block diagrams of a gift certificate request and a gift certificate response in accordance with aspects of certain embodiments;

FIG. 58 illustrates a high level block diagram of entities involved in instant gift certificate transactions in accordance with aspects of the embodiments;

FIG. 59 illustrates a high level block diagram of modules that a facilitator can use in processing instant gift certificate transactions in accordance with aspects of the embodiments;

FIG. 60 illustrates a table of terms and conditions in accordance with aspects of the embodiments;

FIG. 61 illustrates a web page that a facilitator can serve to an organization for designing an instant gift certificate offer page in accordance with aspects of certain embodiments;

FIG. 62 illustrates a web page that a facilitator can serve to an organization for designing an instant logo and instant gift certificates in accordance with aspects of certain embodiments;

FIG. 63 illustrates a high level block diagram of a template that a facilitator can provide an organization for sending instant gift certificate requests and receiving instant gift certificate responses in accordance with aspects of certain embodiments; and

FIG. 64 illustrates a jurisdiction based optimization table in accordance with aspects of certain embodiments.

### DETAILED DESCRIPTION

A personal services related businesses, also called a “personal services vendor” or simply an “organization” has customers. For example, a spa is an organization and a person going to the spa is a customer. Methods and systems are needed that streamline an organization's interactions with customers while retaining the organizations unique identity and advantageously obeying the legal requirements of the organization's legal jurisdiction. A facilitator can provide the needed system and methods.

In general, the facilitator can provide organizations with tools for creating and operating a customized web site. Each organization can easily control the look and feel of its own web site without needing to know any specialized web design language. The facilitator hosts the organization's web site. The facilitator can also provide other functionality to each organization including credit card processing, customer data basing, order taking, gift certificate processing, and customer communications.

The facilitator can provide organizations with an easy way to enter and store information including service offers, service details, service descriptions, service prices. Upon entering the information, the information is stored and immediately appears in the web pages and menus comprising the organizations' web site. The information is easy to enter because there is no need to know the arcane HTML web language or any similar language.

The facilitator can also provide organizations with advanced email facilities. These facilities can be used to email newsletters to customers on a customer list, email messages to customers who have yet to redeem a gift certificate (GC), and email follow up offers. A follow up offer is an offer based on a previous purchase. For example, a husband who bought an anniversary gift certificate can be emailed to remind him of subsequent anniversaries and to make special offers. In general, the advanced email facilities can send email based on rules signifying buying habits, gift certificate status, and other factors.

The facilitator can also provide for reverse aggregation. Aggregation occurs when a customer can redeem a generalized offer at any one of a group of organizations. For example, an aggregator can sell a gift certificate to a customer. The customer can redeem the gift certificate at an organization affiliated with the aggregator. The result is that the customer associates the service with the aggregator and rarely develops a meaningful relationship with the organization. Affiliate business models and franchise business models often use aggregation.

Reverse aggregation occurs when a customer seeking a service is directed to a specific organization. For example, SpaEmergency allows a customer to search for a service based on a set of factors. The factors can include specific service, such as deep massage, geographic area, such as zip code, and availability, such as business hours or open appointments. The customer can then choose a specific spa or salon and receive a gift certificate that is branded for that specific spa or salon. The organization, here a spa or salon, is paid as soon as the customer purchases the certificate, improves cash flow by allowing revenue from unredeemed certificates, and helps prevent the customer from going to a competitor.

An example of a reverse aggregation sales cycle is:
1) Customer searches for and finds a spa or salon that they desire to purchase a gift certificate from after going to the SpaEmergency website;
2) Customer prints out an “Instant Gift Certificate” that is specifically numbered and branded to the spa or salon of interest (hereinafter “Receiving Org”). The customer is instantly gratified and can either print, postal mail or email their gift certificate;
3) The Receiving Org gets a notice from SpaEmergency that a sale was made, and SpaEmergency (vis-à-vis SpaBoom) either processes the credit card (CC) immediately, or provides CC information to enable the Receiving Org to process the CC manually using their offline merchant account;
4) SpaEmergency tallies up sales at the end of the month, and charges a commission to the Receiving Org, based on the net sales made during the month.
5) Customer's lucky recipient redeems their unique gift certificate at their leisure.

As such, some possible reverse aggregation claims are:

The facilitator can additionally provide for third party fulfillment. Third party fulfillment occurs when suppliers, such as manufacturers or other product suppliers, and the facilitator agree to enter the supplier's products into a products database. The products data base contains product information for each product. The product information can include descriptions, pictures, pricing, and an identifier such as a stock keeping unit (SKU).

An organization can choose to use the facilitator to sell products. The facilitator provides an interface, such as a set of web pages, to the organization. The organization uses the interface to select products to sell. The selected products are automatically offered for sale on the organization's web site. The facilitator can also provide the organization with a design interface that can be used to customize the web pages containing the product offers.

When a customer purchases a product, the facilitator handles fulfillment. Fulfillment means delivering goods or services to a customer. As such, the facilitator can drop ship products from stock on hand. The facilitator can also forward information to one or more of the suppliers who then handles fulfillment. Many organizations, however, prefer branded fulfillment. To provide branded fulfillment, the products can be shipped to the customer in boxes branded for the organization and with invoices, receipts and labels branded for the organizations. For example, if Mack orders conditioner from Joe's Salon then Mack receives conditioner in a box with Joe's Salon labeling. Mack's order receipt says the order is from Joe's Salon.

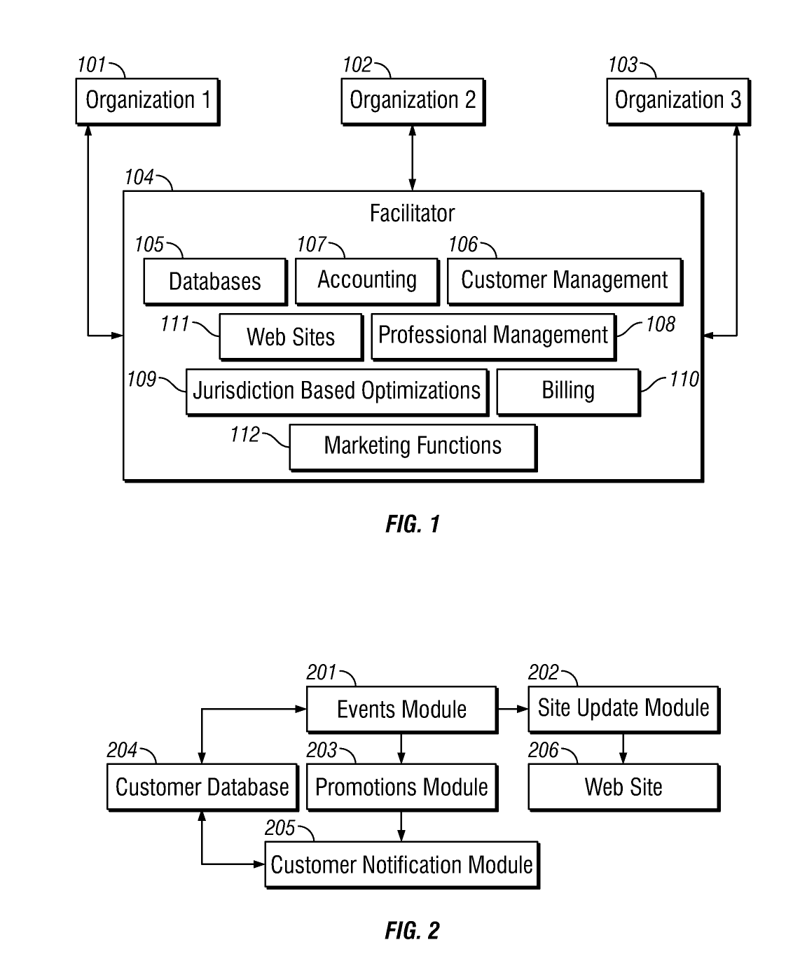

FIG. 1 illustrates a first organization 101, a second organization 102, and a third organization 103 all using the same aggregated information systems provider 104. The aggregated information systems provider 104 can supply database solutions 105, client management solutions 106, accounting solutions 107, professional management solutions 108, billing solutions 110, web sites 111, jurisdiction based optimizations 109, and marketing functions 112.

Jurisdiction based optimizations are requirements or opportunities that arise based on the jurisdiction in which an organization operates. The most obvious jurisdiction based requirement is taxes. Different jurisdictions often have different taxation rates and schemes. Jurisdiction based optimizations, however, are often less obvious. For example, different jurisdictions have different rules for gift certificates. Some jurisdictions do not allow gift certificates to expire. Others impose a minimum period until expiration. Some jurisdictions allow gift certificates to simply expire while others require that the value of the certificate be reimbursed to somebody or something. Each organization can automatically enjoy customized and optimized gift certificate capabilities by using jurisdiction based optimizations 109. For example, the terms and conditions printed on the gift certificate can be based on the laws of the jurisdiction that the services provider uses.

FIG. 2 illustrates a high level block diagram of a system that automatically notifies clients of upcoming events and produces event based modifications to a web site. An events module 201 keeps track of special events such as Valentines Day, Mother's Day, and client birthdays. An upcoming event can trigger a promotions module 203 that produces client notifications such as advertisements or coupons. The client notification module 205 interacts with the client database 204 and causes clients to receive the notifications. A notification can be emailed, mailed, phoned, faxed, texted, or communicated to the client in some other manner. The client database 204 can contain client notification preferences so that some clients can be emailed while others receive regular mail. This configuration also enables each organization to maintain CAN-SPAM compliance or adhere to other form of legal communications requirements.

The events module 201 also alerts a site update module 202 about an upcoming event. The site update module 202 can update a website 206. For example, one month before Mother's Day, the events module can alert the site update module 202 that Mother's Day is near. The site update module 202 can then update the website 206 with special Mother's Day content. The events module 201 also alerts the site update module 202 when there is no event near. As such, after Mother's Day, the events module 201 alerts the site update module 202 causing the web site 206 to display its normal content.

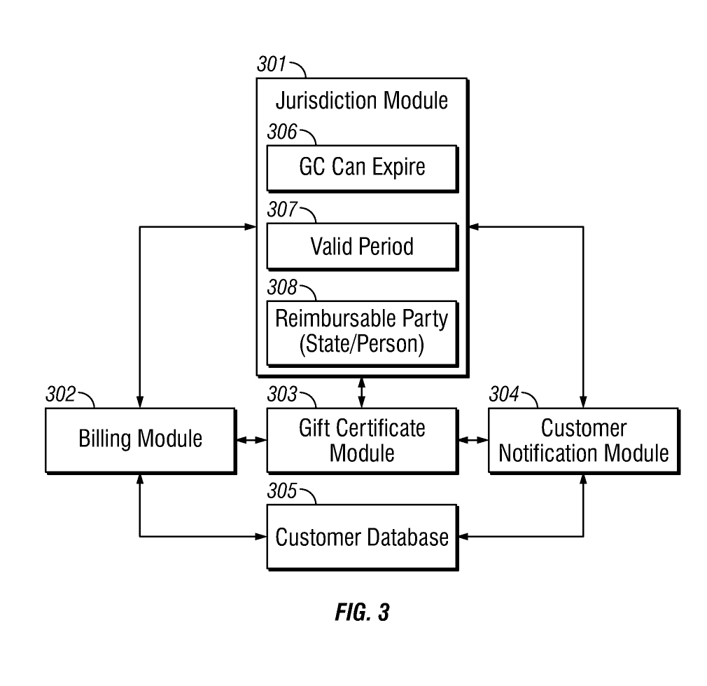

FIG. 3 illustrates interactions involving a jurisdiction module 301. The jurisdiction module 301 contains information about different laws in different jurisdictions. Here, the jurisdiction module 301 contains information regarding the legality of expiring gift certificates 306, how long gift certificates must be valid 307 and who gets the money when a gift certificate expires 308. A gift certificate module 303 can produce a gift certificate. It queries the jurisdiction module 301 to find what terms to print on the gift certificate.

A billing module 302 can collect or record payment for a gift certificate. Payment can be collected by charging a credit card. If money has already been collected, payment can be simply recorded. For example, an in person cash payment at a personal services provider's location results in money already received. In other words, someone walks into the store and buys a gift certificate with cash and a cashier uses the computer as a point of sales device (cash register) and to generate the gift certificate. Another possibility is that a client regifts by using the balance on their own gift certificate to purchase one for someone else. The billing module 302 can also interact with the jurisdiction module 301 and a client database 305.

The gift certificate (GC) module 303 can also trigger a client notification module 304 to cause delivery of the gift certificate. The client notification module 304 can interact with the client database 305 to obtain information such as the client home address or email address.

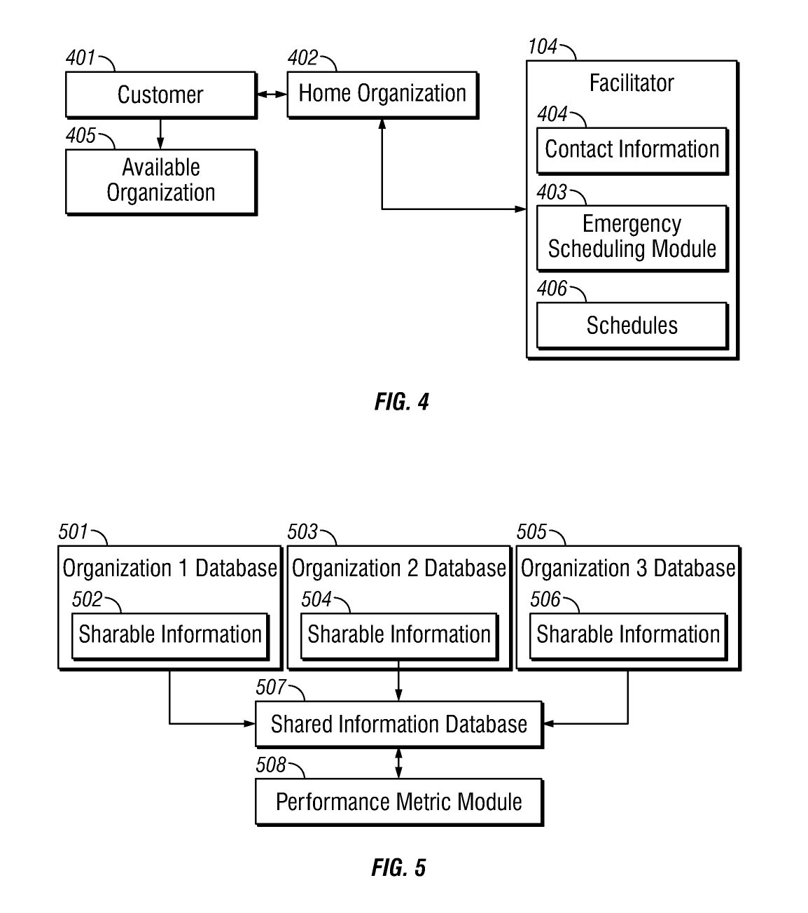

FIG. 4 illustrates a client 401 seeking services in an emergency. The client 401 contacts their home vendor 402 with whom they normally do business. The client 401 communicates the client location and schedule. The home vendor 402 passes the information to the aggregated information systems provider 104 that uses an emergency scheduling module 403. The emergency scheduling module examines the schedules 406 and contact information 404 of services providers to locate those that are available. The available service providers are those close to the client and have open schedules when the client 401 wants. Information about available service providers is passed to the client 401 by way of the home vendor 402. The client 401 can then schedule an appointment with an available services provider 405.

FIG. 5 illustrates obtaining performance metrics. A first vendor has a database 501 that contains sharable information 502. A second vendor also has a database 503 containing sharable information 504. Additionally, a third vendor has a database 505 containing sharable information 506. Each vendor can choose which information is sharable. For example, certain aggregate billing, collections, and utilization information can be shared while client data is held private. A shared information database 507 collects the shared information. A performance metric module 508 queries the shared information database 507 to assemble performance metrics. A performance metric is a measure of how well one services provider is performing a function or how well a group of services providers is performing a function. For example, a services provider interested in gross margins for his own business as compared to a group of similarly sized services providers would use the performance metric module 508 to obtain the data.

Gross margins are one performance metric. Other performance metrics include but are not limited to overall sales numbers and revenue totals (hereinafter “sales”), sales conversions, repeat sales, new sales, sales by event, sales by occasion, sales by service, sales by geographic location or region, sales by referrer, sales by search term, GC design preference, and event and occasion preferences.

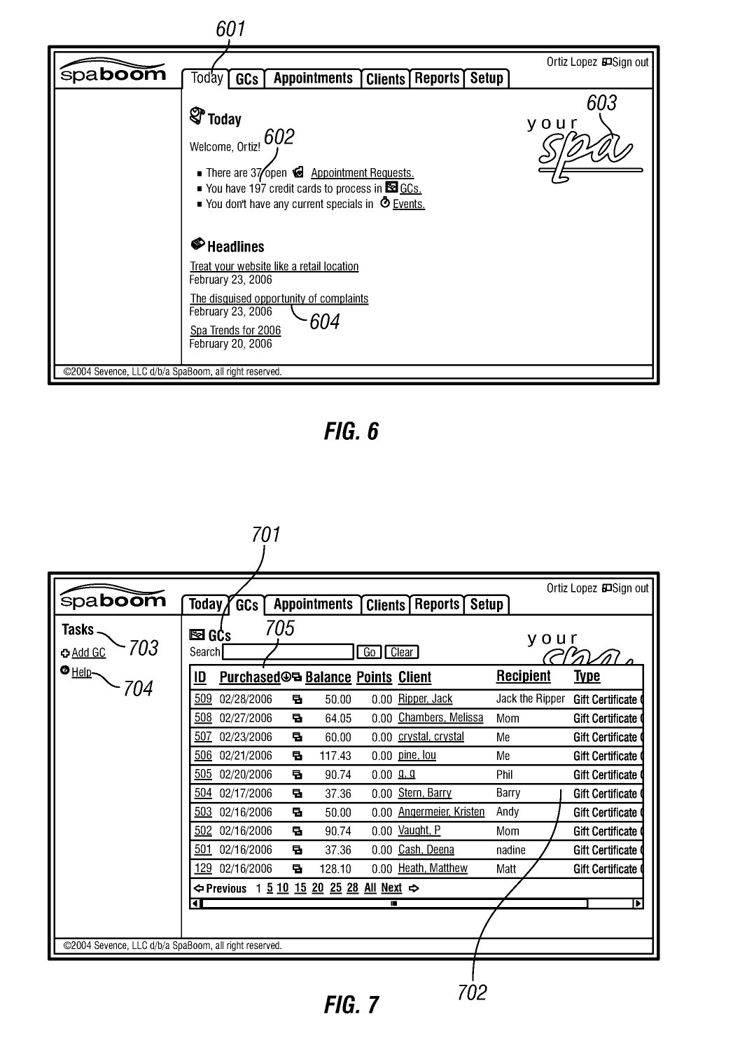

FIG. 6 illustrates the “Today” page of the SpaBoom website. The “Today” tab 601 is active. User news 602 is presented for the specific user or services vendor while headlines 604 are items of general interest. The logo 603 of the spa is presented on the right hand side of the page.

FIG. 7 illustrates a GC, or gift certificate, summary page. The GCs tab is active and the GCs locator 701 is presented. A Tasks menu 703 is presented in the left sidebar presenting options 704 to add GC or get help. A GC data table 702 is presented with each row containing data for one gift certificate. The table appears sorted in accordance with a sort arrow 705. The sort arrow can be selected to change the sort direction. Selecting a column heading can cause the table to be presented as sorted along that column. Here, the table is presented as sorted by the gift certificate purchase date with the newest purchases appearing first.

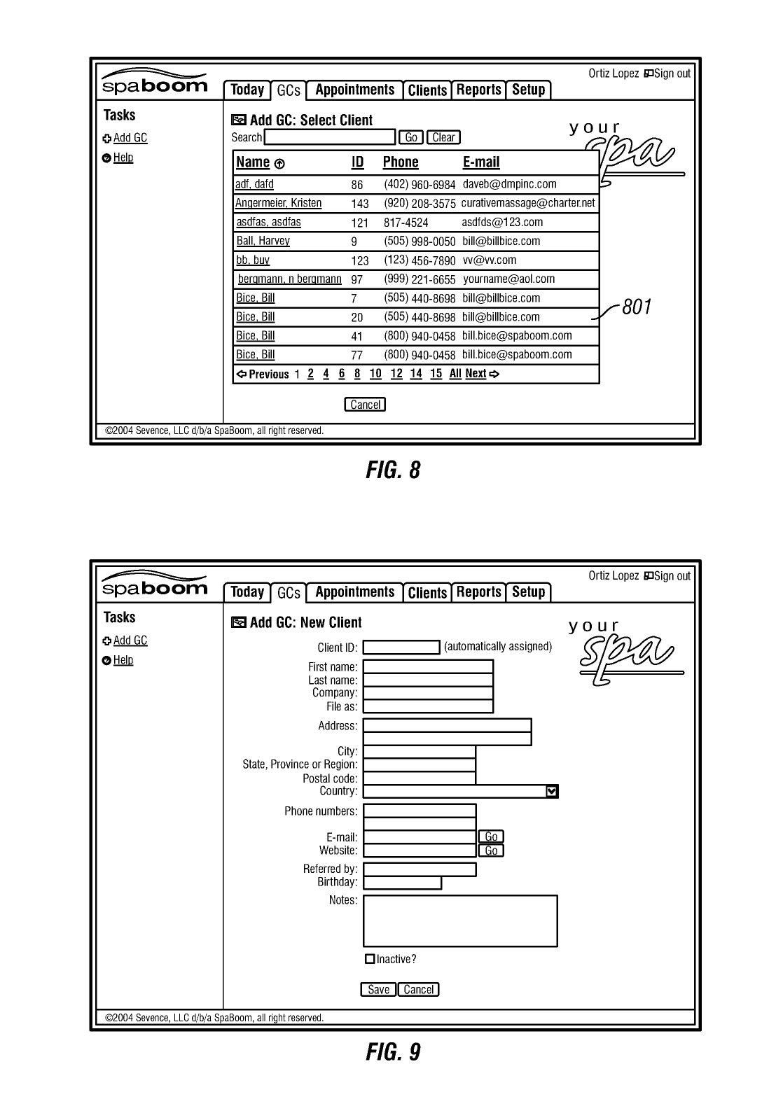

FIG. 8 illustrates the “Add GC” page used for adding in a new gift certificate. The client table 801 presents a table of clients and client information. As can be seen, the tasks menu presents the option to add a new client. FIG. 9 illustrates a page for adding a new client wherein the fields are self explanatory.

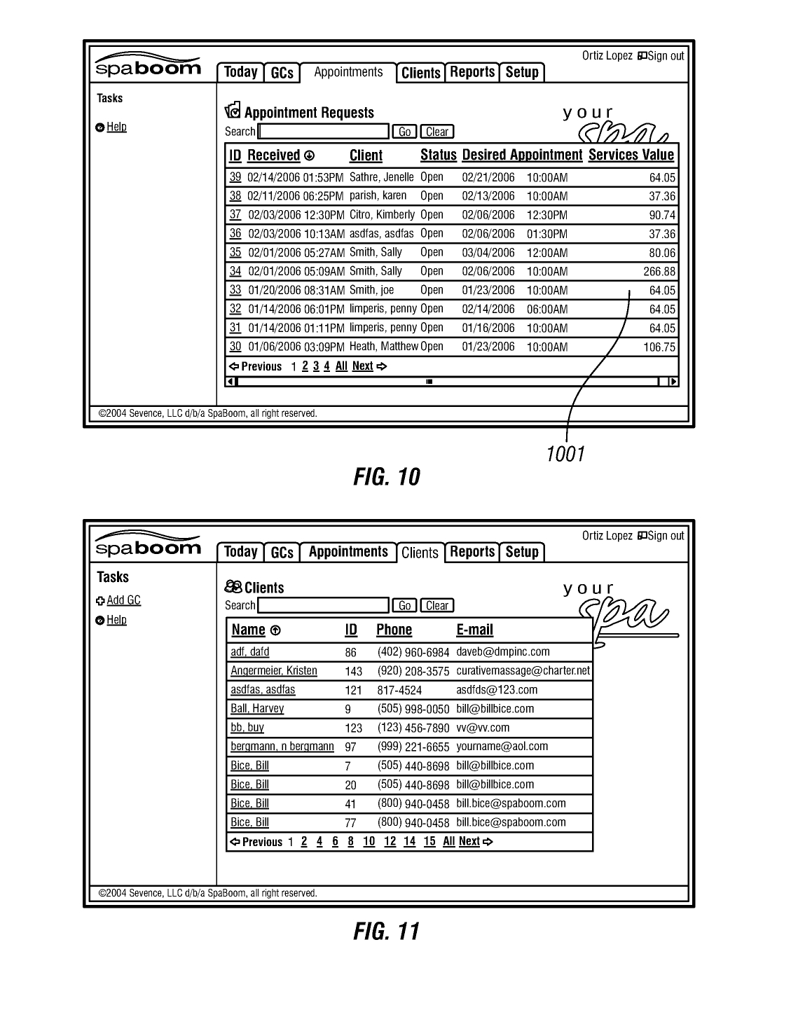

FIG. 10 illustrates an Appointments page containing an appointments table 1001. The appointments tab is active and the “Appointment Request” locator is displayed. The appointments table 1001 presents a sorted table of appointment data.

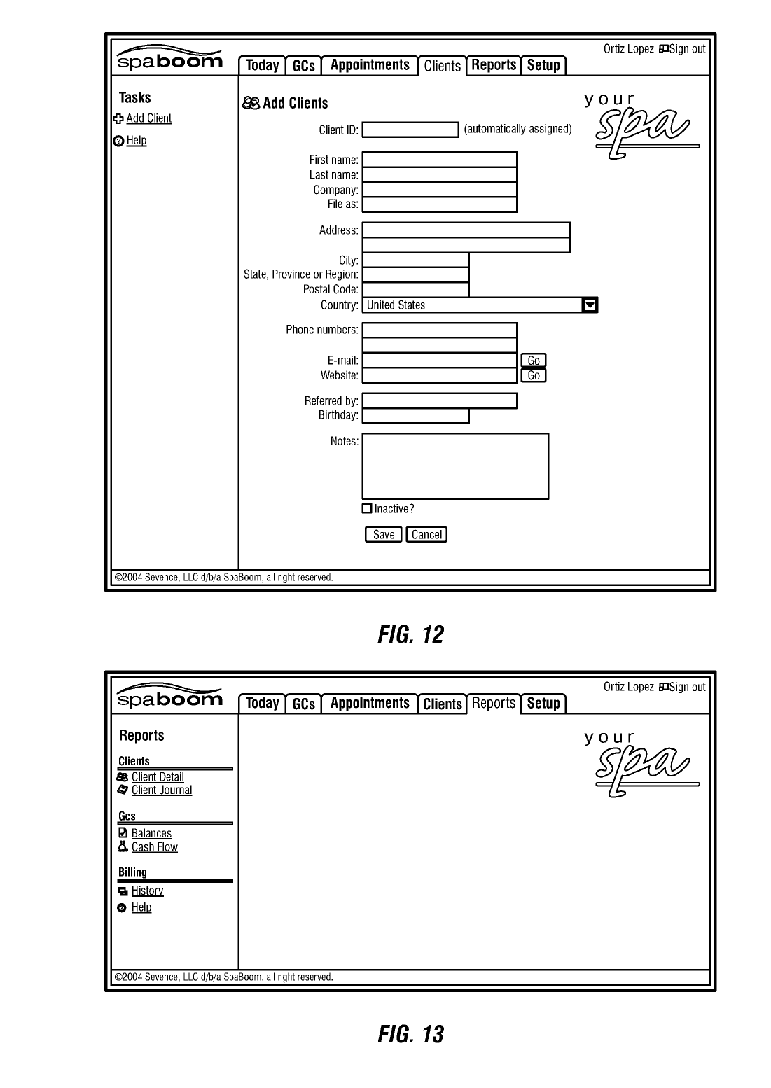

FIG. 11 illustrates a “Clients” page that is similar to that of FIG. 8. The Clients tab is active and the “Clients” locator is displayed. Notice that the FIG. 8 has the “Add GC: Select Client” locator displayed indicating that it was accessed from the GC page. Similarly, FIG. 12 presents an “Add Client” page that is similar to that of FIG. 9 with the exception of a different locator.

FIG. 13 illustrates the main “Reports” page that presents a Reports menu in the left side bar.

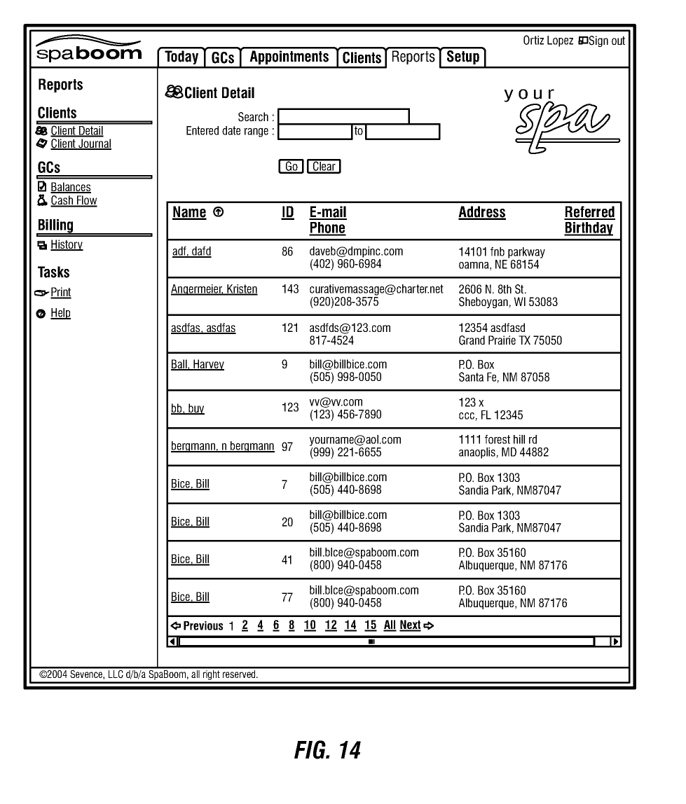

FIG. 14 illustrates the “Client Detail” page accessed via the “Client Detail” link on Reports left side bar. As can be seen, the client detail table contains more information than the client tables illustrated above.

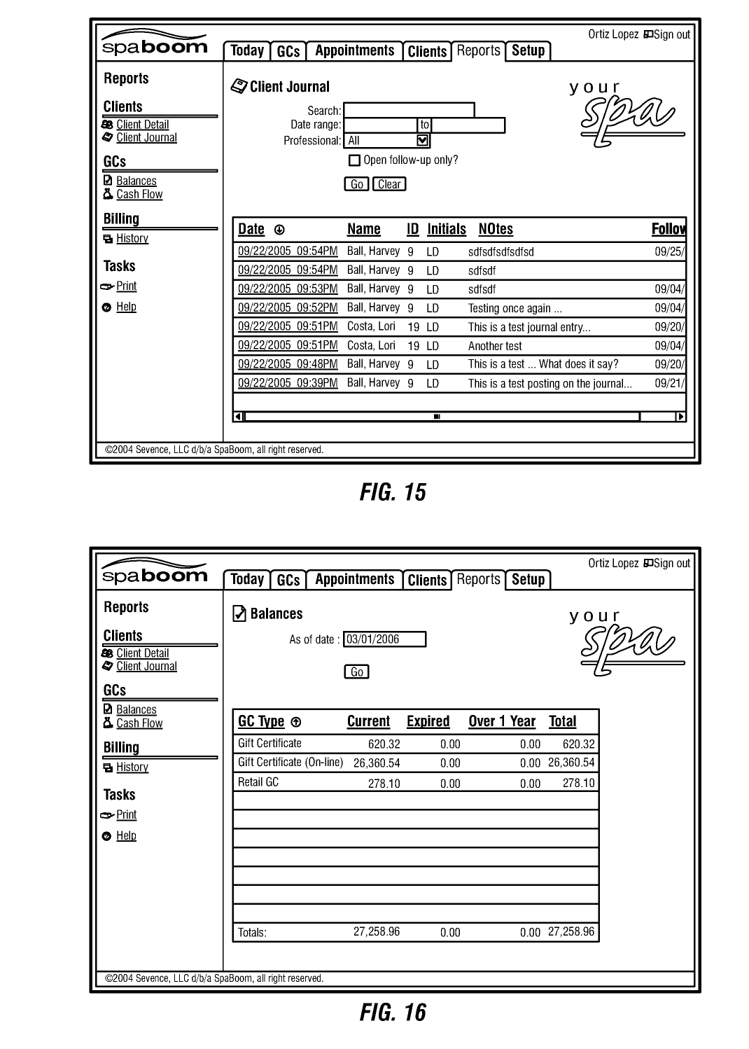

FIG. 15 illustrates the “Client Journal” page accessed via the “Client Journal” link on the Reports left side bar. The journal table has a single journal entry per row giving the date, client name and Id, the name of the journal entry creator, a note, and a date on which to follow up on the journal entry. The journal is used to log data about specific clients and events that should be remembered, communicated, or followed up.

FIG. 16 illustrates the “Balances” page accessed via the “Balances” link on the Reports left side bar. Each GC type has a row in the balances table. The balances shown are self explanatory totals for each GC type.

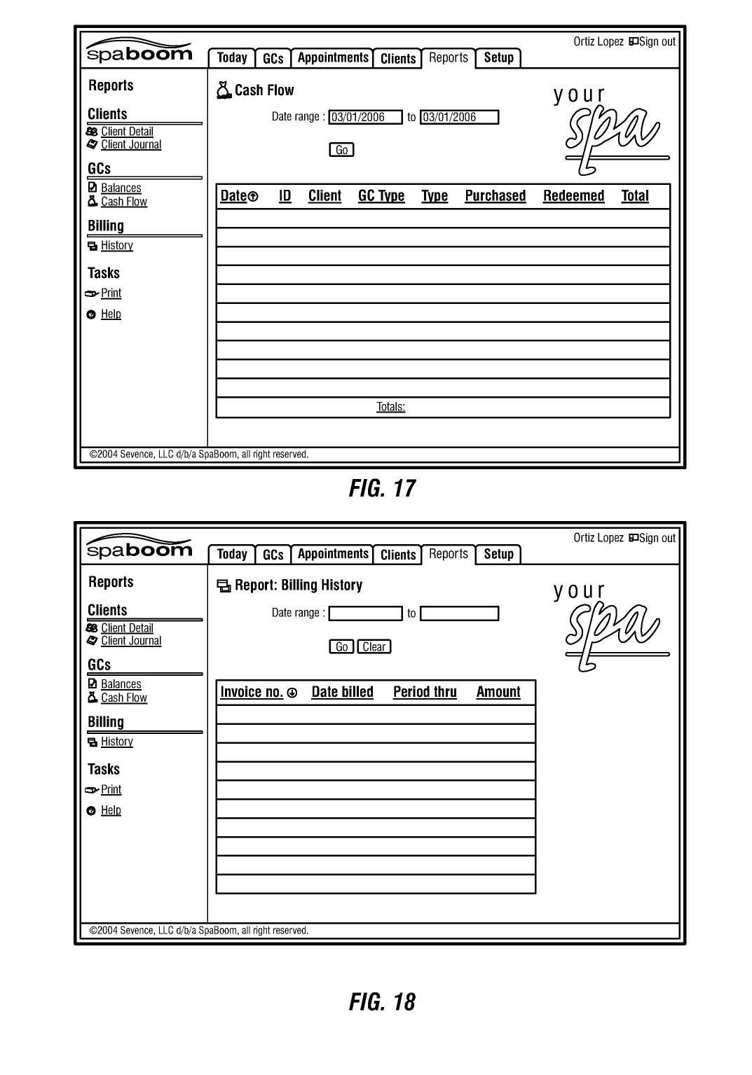

FIG. 17 illustrates the “Cash Flow” page accessed via the “Cash Flow” link on the Reports left side bar. The columnar data shown are self explanatory.

FIG. 18 illustrates the “Report: Billing History” page accessed via the “Billing History” link on the Reports left side bar. Each invoice has a row in the invoice table. The columnar data shown are self explanatory for each invoice.

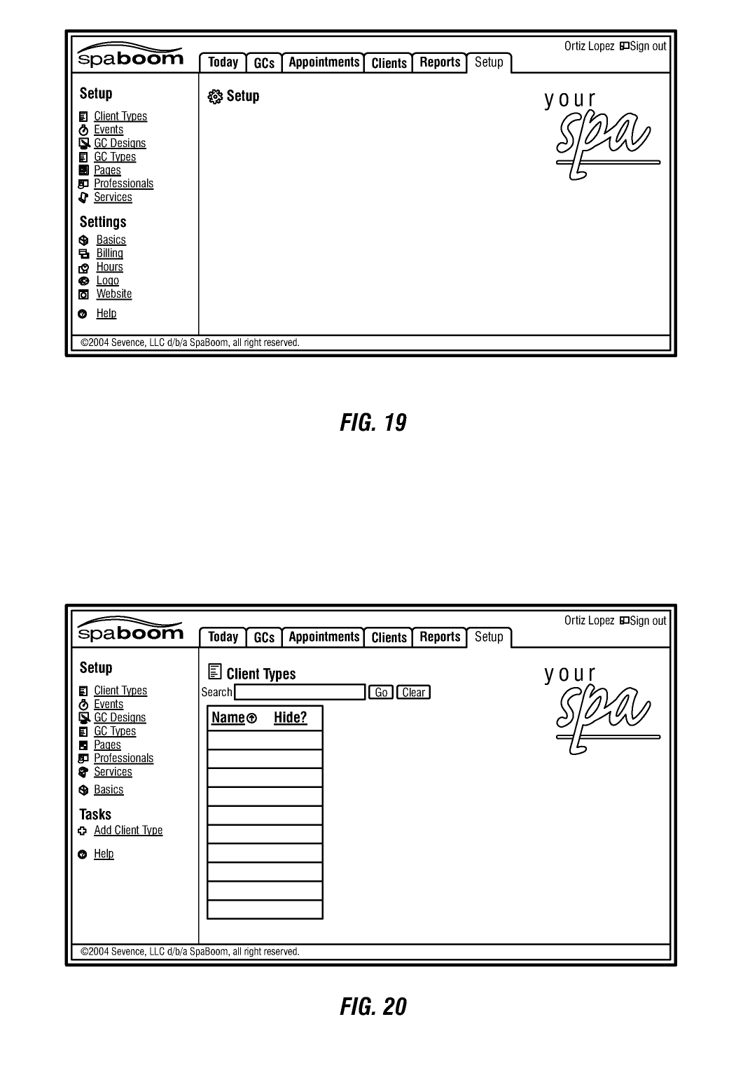

FIG. 19 illustrates the main “Setup” page that presents a Setup menu and a Settings menu in the left side bar.

FIG. 20 illustrates the “Client Types” page accessed via the “Client Types” link in the Setup menu. Each client type has a row in the client type table. The columnar data shown are self explanatory for each client type. Notice that a context sensitive tasks menu appears in the left side bar.

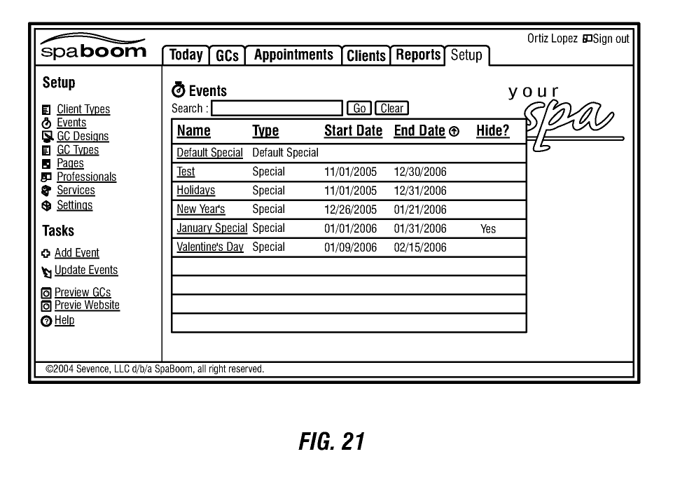

FIG. 21 illustrates the “Events” page accessed via the “Events” link in the Setup menu. Each event has a row in the client type table. The columnar data shown are self explanatory for each event. The events shown correspond to those handled by the Events Module of FIG. 2.

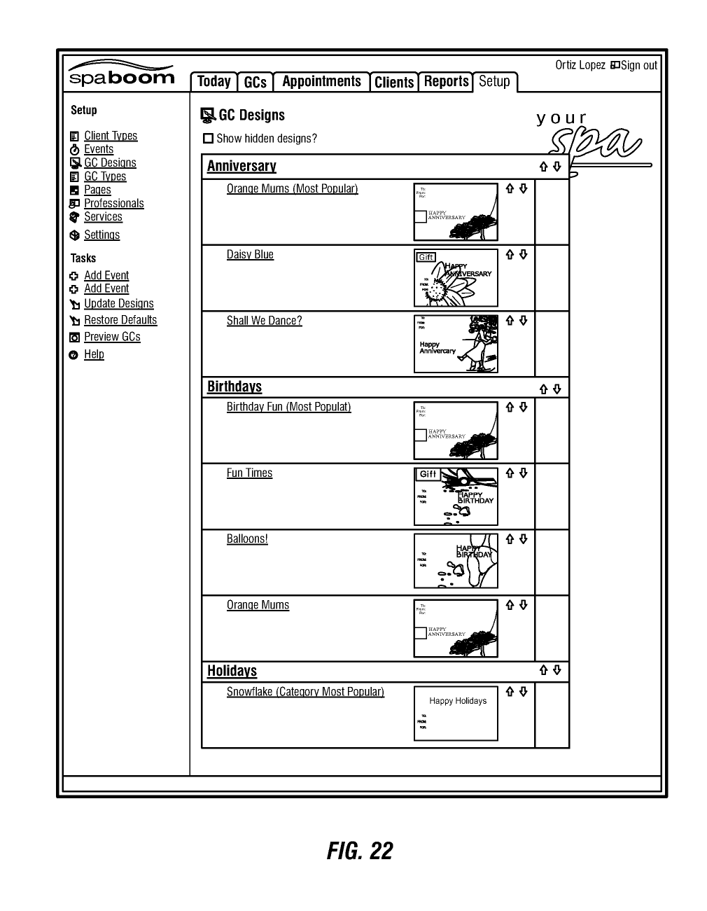

FIG. 22 illustrates the “GC Designs” page accessed via the “GC Designs” link in the Setup menu. A number of GC categories are presented such as “Anniversary”, “Birthdays”, and “Holidays”. The GC designs, such as “Orange Mums”, “Daisy Blue”, and “Shall We Dance?” are presented within a GC category. The show hidden designs button causes all of the designs and categories to be displayed. A hidden GC design or GC category is one wherein the “hidden” property is set resulting in the GC design not being displayed. Notice that the context sensitive tasks menu presents options for adding categories and designs as well as other tasks.

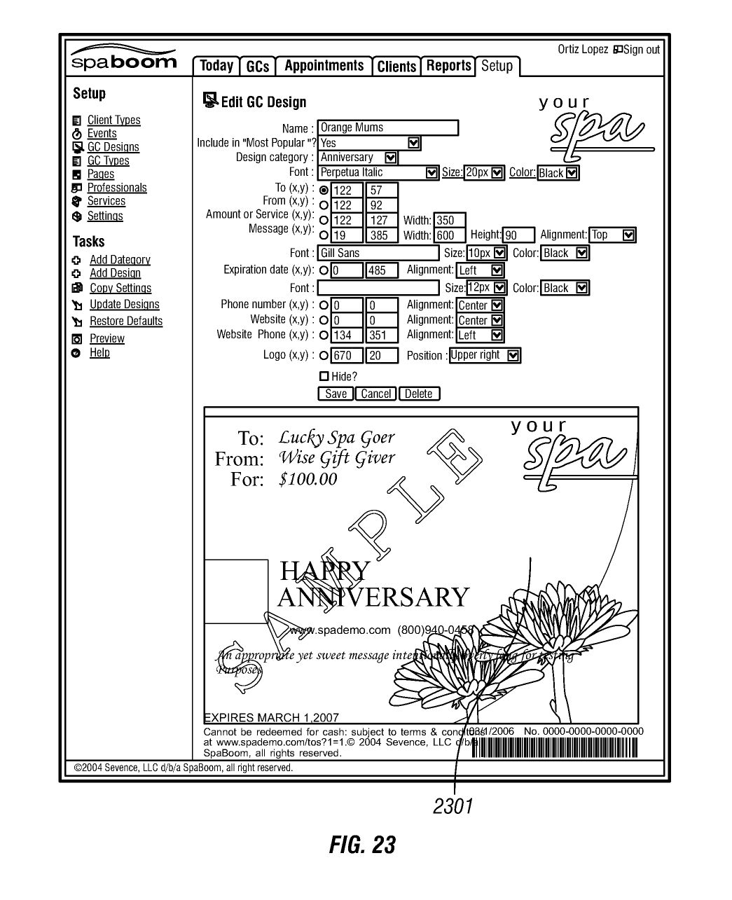

FIG. 23 illustrates the “Edit GC Design” page accessed by clicking on a GC design, such as “Orange Mums”, on the “GC Designs” page. The text entry fields are largely self explanatory. The hide button can be selected to set the design's “hidden” property. A sample GC is displayed at the bottom of the page 2301. Note that this functionality makes it possible for personal services vendors to have their own unique, custom designed GC's as part of the offering to the end customer. This makes it possible to present SpaBoom GC designs, custom GC designs, or a combination thereof to the end customers.

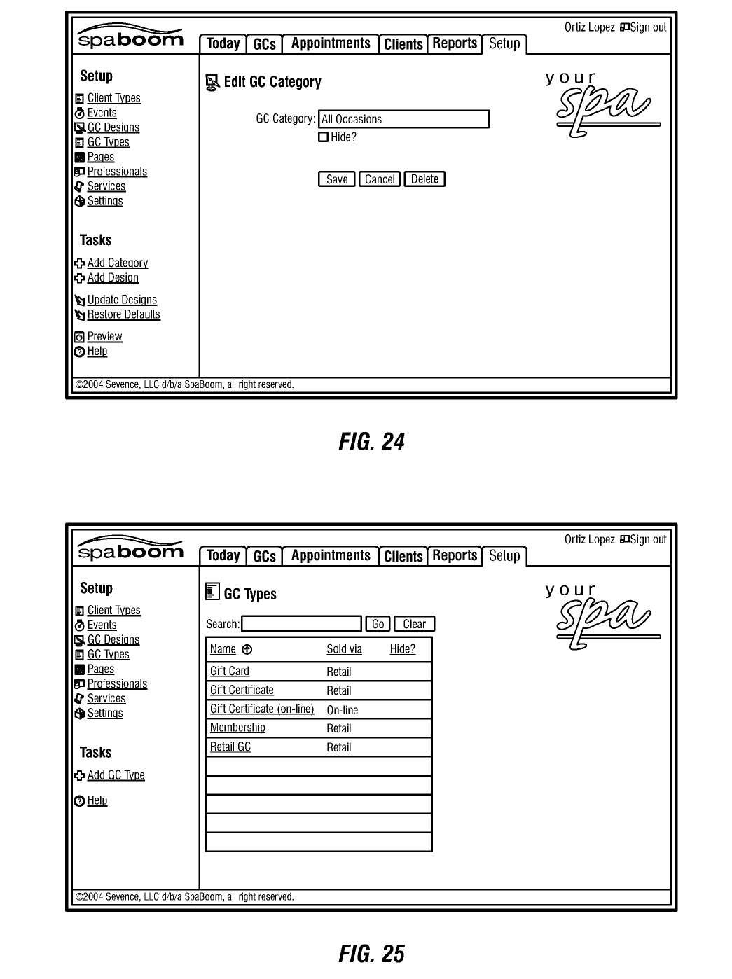

FIG. 24 illustrates the “Edit GC Category” page accessed by clicking on a GC category, such as “All Occasions”, on the “GC Designs” page. The text entry field is self explanatory, being used for entering and presenting the GC category identifier. The hide button can be selected to set the category's “hidden” property.

FIG. 25 illustrates the “GC Types” page accessed via the “GC Types” link in the Setup menu. Each GC type has a row in the GC type table. The columnar data shown are self explanatory.

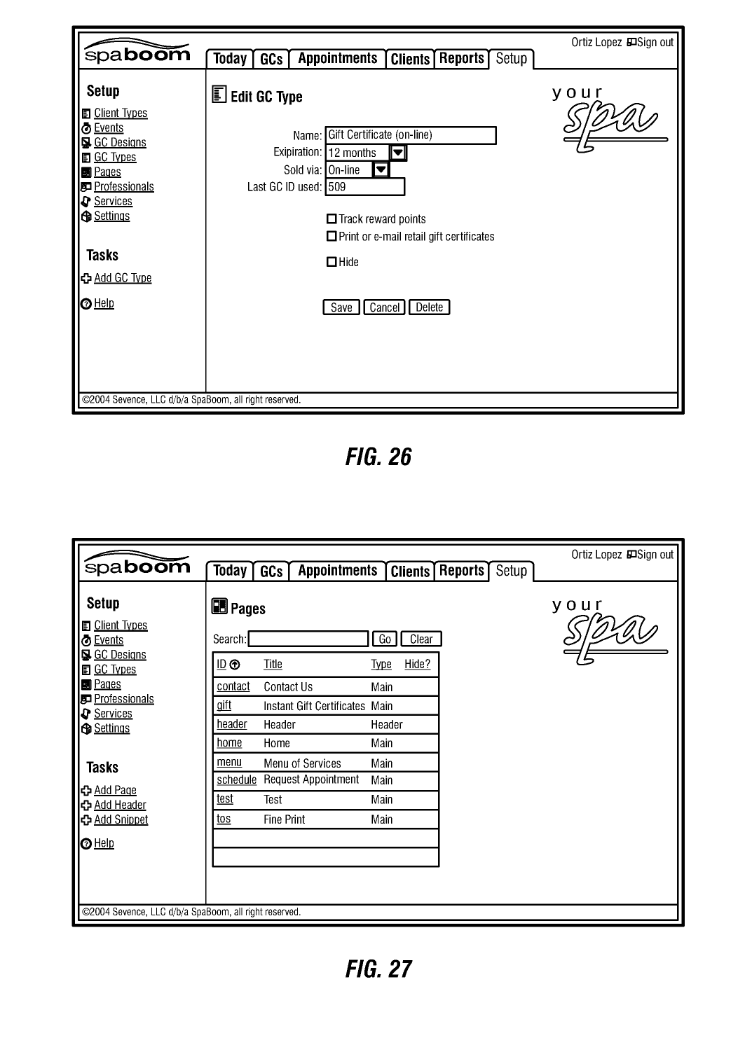

FIG. 26 illustrates the “Edit GC Type” page accessed by clicking on a GC type on the “GC Types” page. The text entry fields are self explanatory. The track reward points check box allows the GC to be part of a rewards point program. Contemporary consumers are familiar with rewards programs wherein additional service, coupons, or cash rebates are earned. This functionality makes it possible to manage different GC types, such as GCs of different GC type having different expiration dates.

FIG. 27 illustrates the “Pages” page accessed via the “Pages” link in the Setup menu. Each page of the service provider's web site is represented by a row in the pages table. The ID is the page's identifier. The title is the text that can be displayed in a web browser's title bar when the page is displayed in the web browser's content area. The type is either “main”, “header”, or “snippet”.

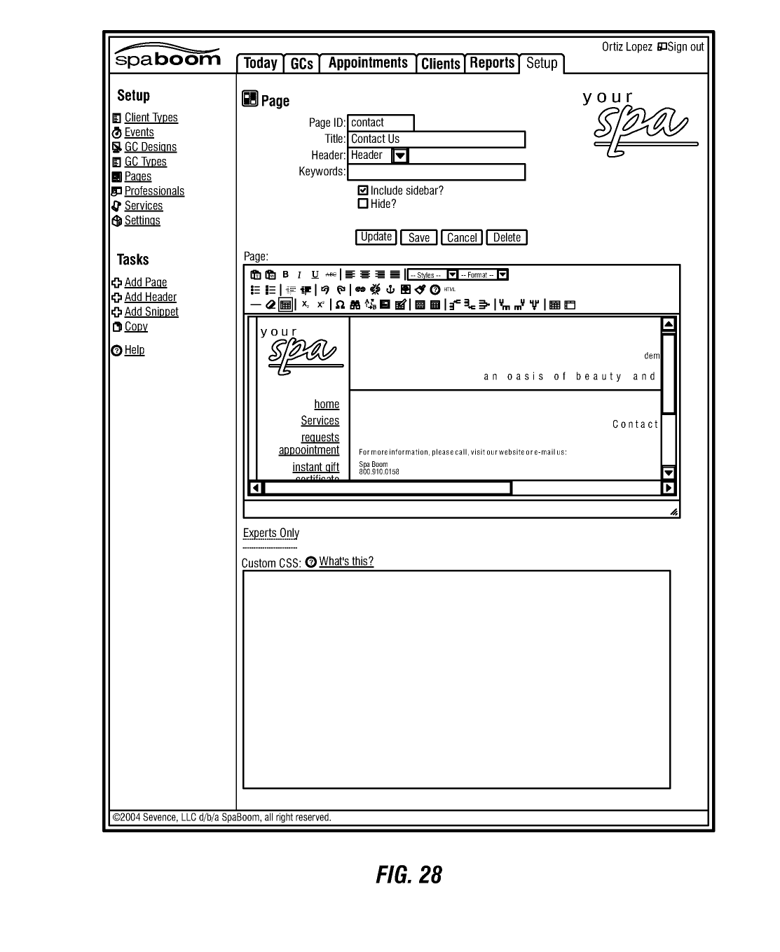

FIG. 28 illustrates the “Page” page accessed via the “Add Page” link in the context sensitive Tasks menu. The text entry fields are largely self explanatory in corresponding to fields displayed in FIG. 27. The Header property selects the web page's header. The keywords field selects certain key words that can be placed in the page as metadata helpful to search engines. A web based authoring tool 2801 can also set the pages content. The “Experts Only” link opens up the “Custom CSS” areas. Those skilled in web page design are familiar with all the aspects of web page design and editing presented in FIG. 28.

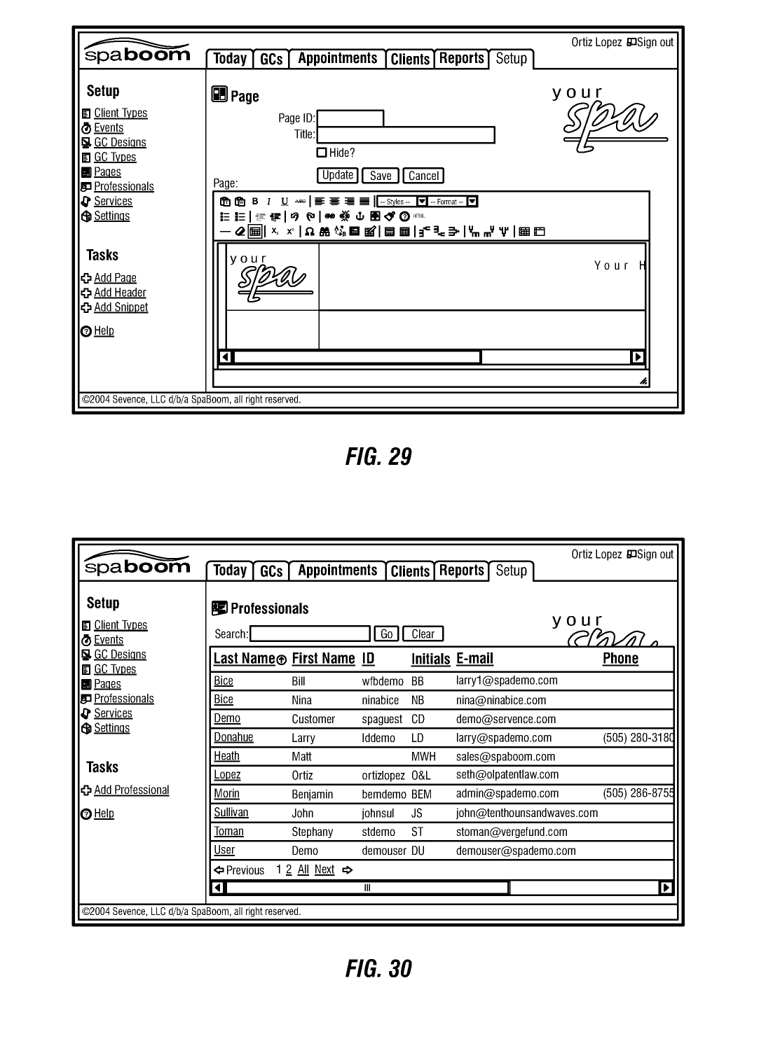

FIG. 29 illustrates the Header page, currently labeled “Page”, that can be accessed via the “Add Header” link in the context sensitive Tasks menu. The principal difference between the Header page and the “Page” page is that there is no field for selecting a header's header. Those skilled in web page design are familiar with all the aspects of web page design and editing presented in FIG. 29.

FIG. 30 illustrates the “Professionals” page accessed via the “Professionals” link in the Setup menu. A professional is a person who can perform personal services for a client. The professional can be an employee of the personal services vendor. The columnar data shown are self explanatory for each professional.

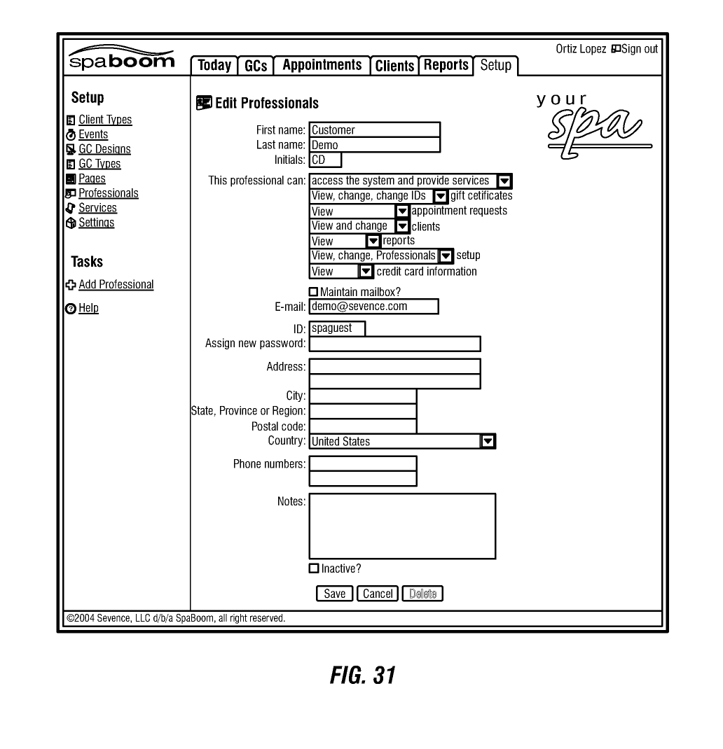

FIG. 31 illustrates the “Edit Professional” page accessed by clicking on a last name on the “Professionals” page. The text entry fields are self explanatory.

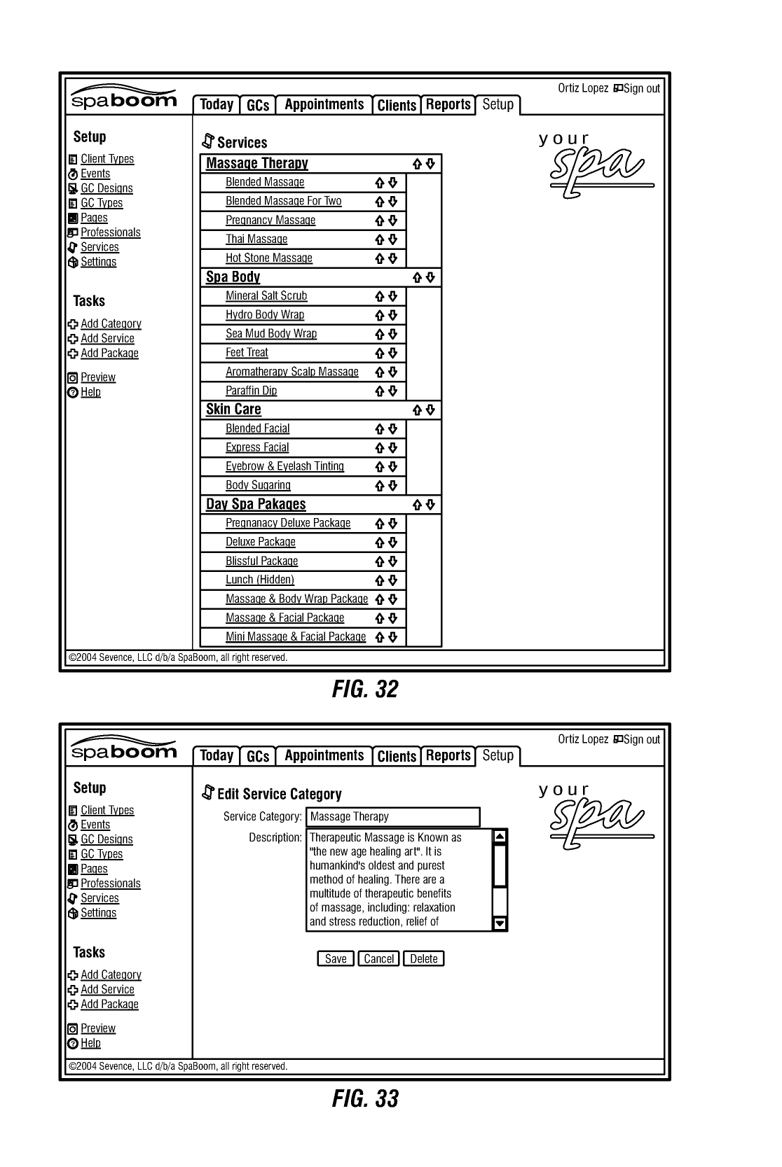

FIG. 32 illustrates the “Services” page accessed via the “Services” link in the Setup menu. Service categories, such as “Massage Therapy”, “Spa Body”, and “Skin Care” are displayed. Service packages, such as “Blissful Package”, are shown under the “Day Spa Packages” heading. Each service, such as “Blended Massage” or “That Massage” is presented within a service category.

FIG. 33 illustrates the “Edit Service Category” page accessed by clicking on a service category on the “Services” page. The text entry fields are self explanatory.

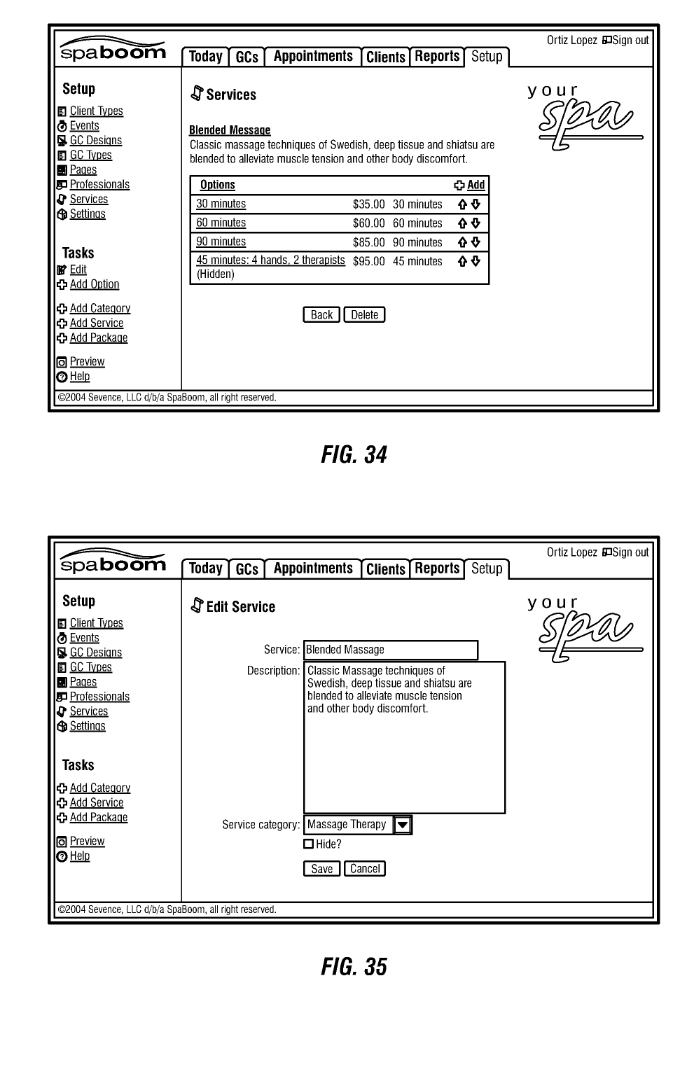

FIG. 34 illustrates the “Service” page accessed by clicking on a service on the “Services” page. Each service option is represented by a row in the service table specifying a level of personal service, price, and amount of time. Additional service options can be added by clicking the “Add” link.

FIG. 35 illustrates the “Edit Service” page accessed by clicking on a service on the “Services” page. The text entry fields are self explanatory.

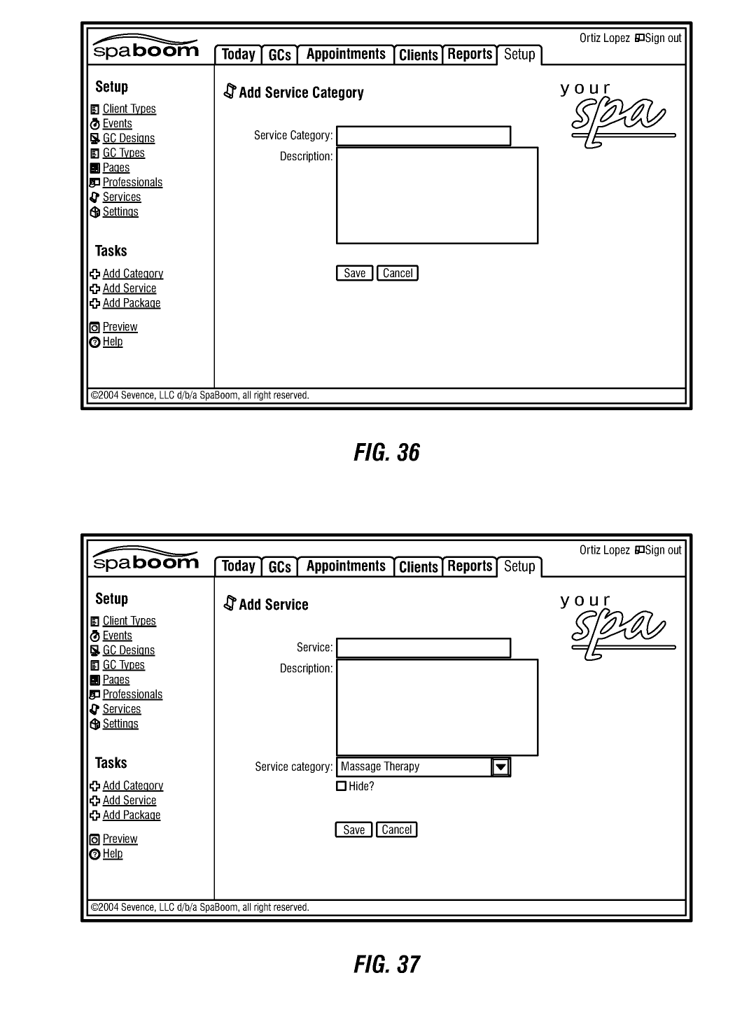

FIG. 36 illustrates the “Add Service Category” page accessed by clicking on the “Add Category” link in the context sensitive tasks menu. The text entry fields are self explanatory.

FIG. 37 illustrates the “Add Service” page accessed by clicking on the “Add Service” link in the context sensitive tasks menu. The text entry fields are self explanatory.

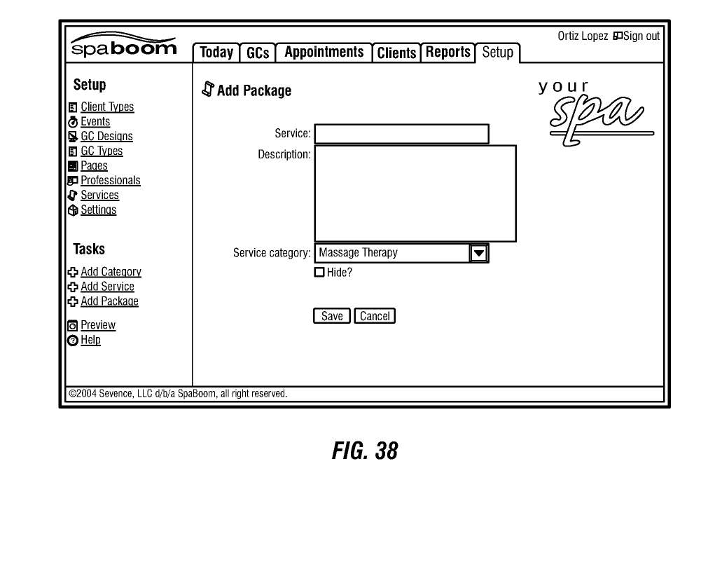

FIG. 38 illustrates the “Add Package” page accessed by clicking on the “Add Package” link in the context sensitive tasks menu. The text entry fields are self explanatory.

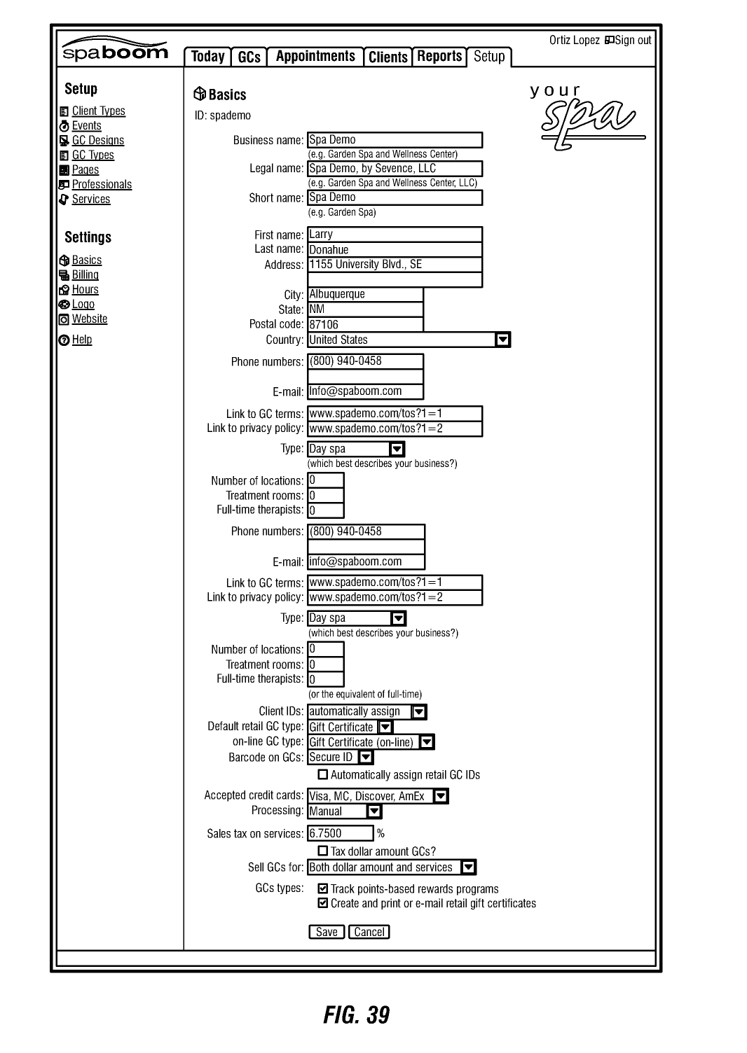

FIG. 39 illustrates the “Basics” page accessed by clicking on the “Basics” link in the settings menu. The text entry fields are self explanatory and specify details about a specific services vendor.

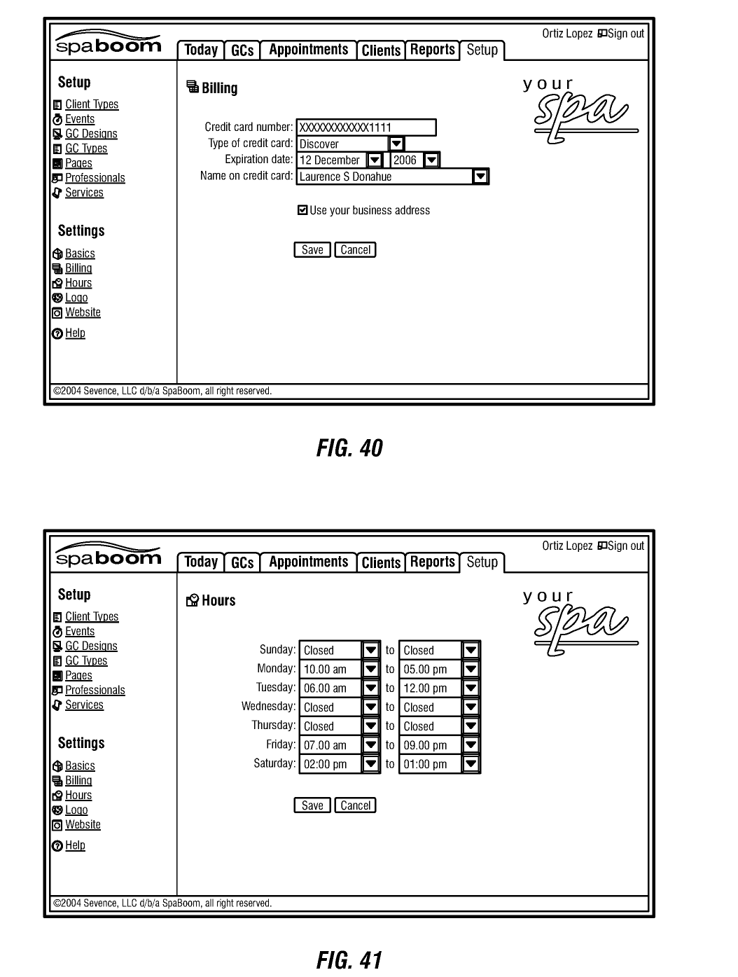

FIG. 40 illustrates the “Billing” page accessed by clicking on the “Billing” link in the settings menu. The text entry fields are self explanatory and specify details required for billing a specific services vendor.

FIG. 41 illustrates the “Hours” page accessed by clicking on the “Hours” link in the settings menu. The text entry fields are self explanatory and specify the hours of operation of a specific services vendor.

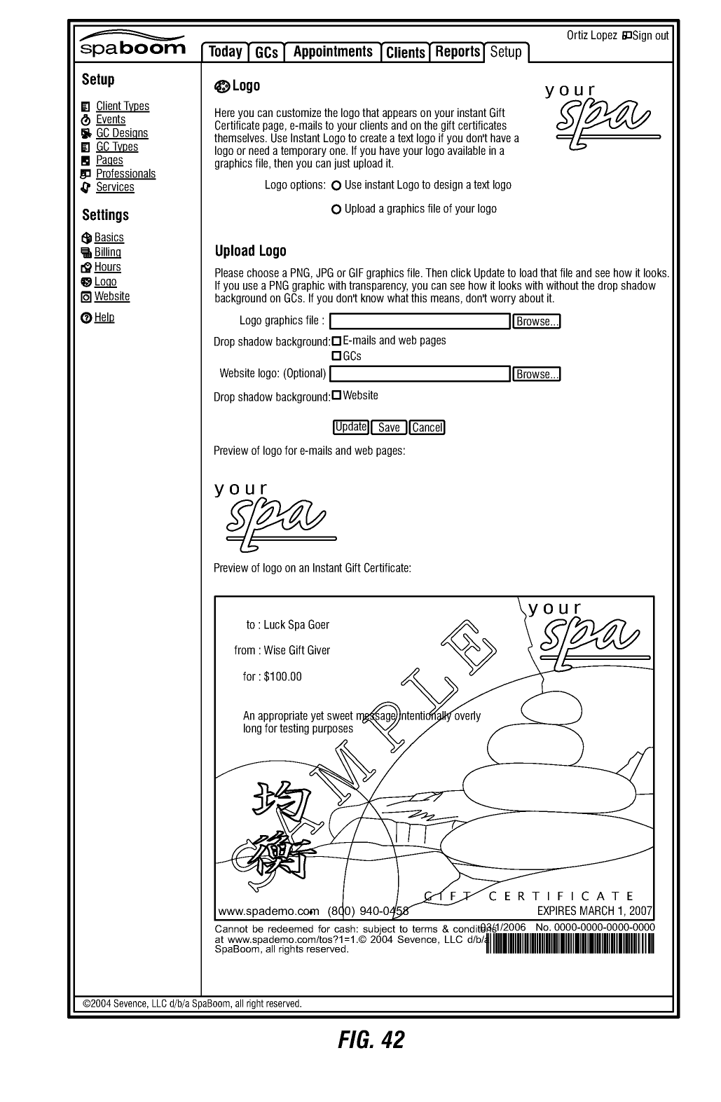

FIG. 42 illustrates the “Logo” page accessed by clicking on the “Logo” link in the settings menu. The page and its function are self explanatory as can be seen by reading the text in the FIG. 42. An example gift certificate is presented at the bottom of the page. Note that the page header and trailer are cropped from FIG. 42.

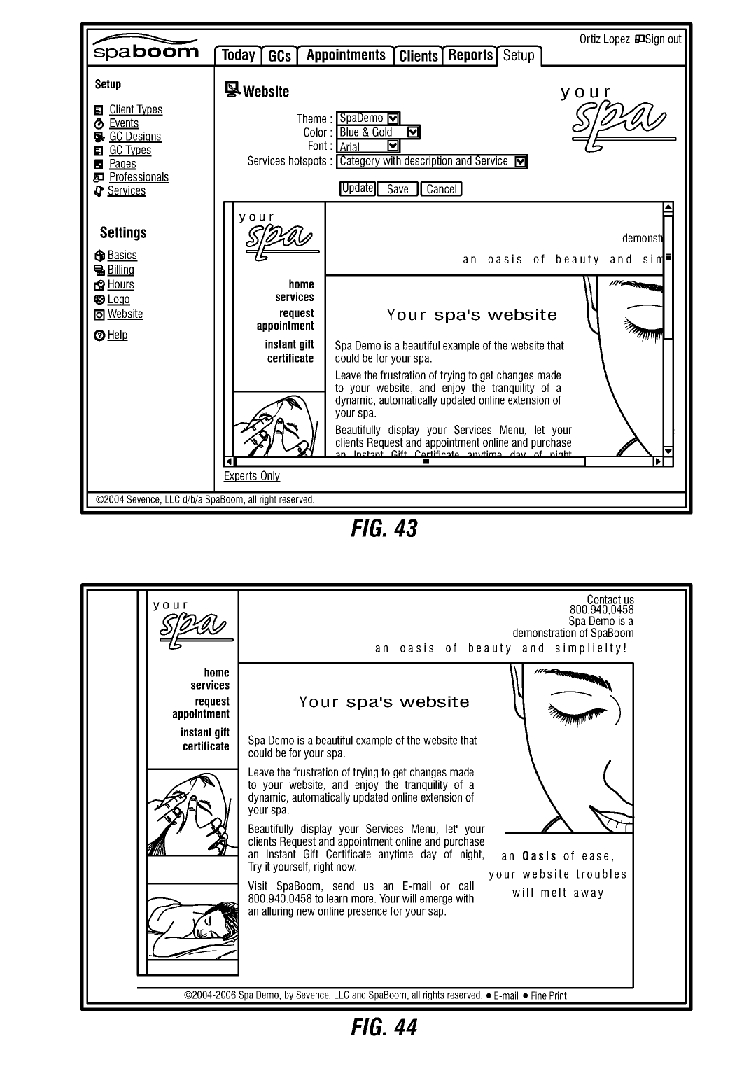

FIG. 43 illustrates the “Website” page accessed by clicking on the “Website” link in the settings menu. The text entry fields are used to set parameters used in generating a website for the personal services provider.

FIG. 44 illustrates the home page for a personal services vendor. All of the elements displayed as a part of the website can be set using the input fields presented in FIGS. 1-43.

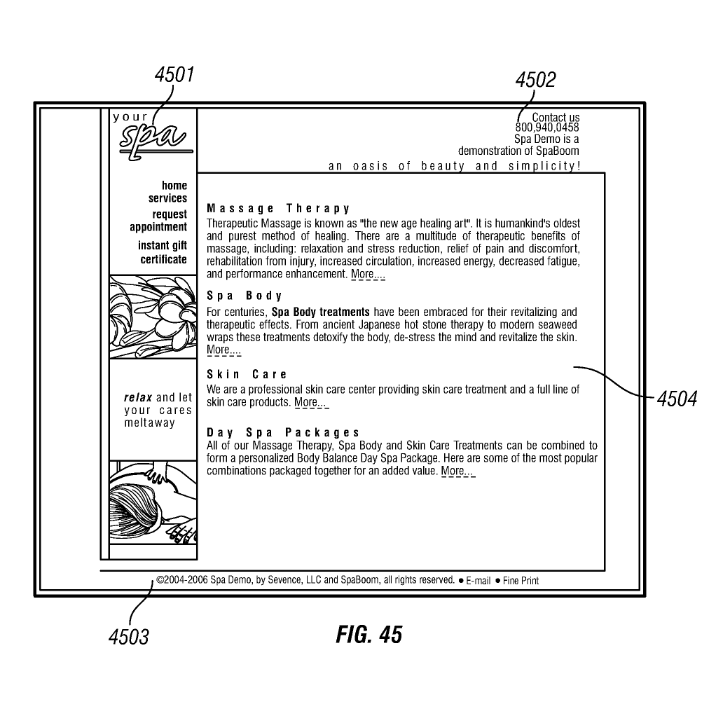

FIG. 45 illustrates the services page of a personal services vendor's website. The sidebar 4501, header 4502, and trailer 4503 are used as common elements in many of the web pages. The service content area 4504 displays service category information matching that input above.

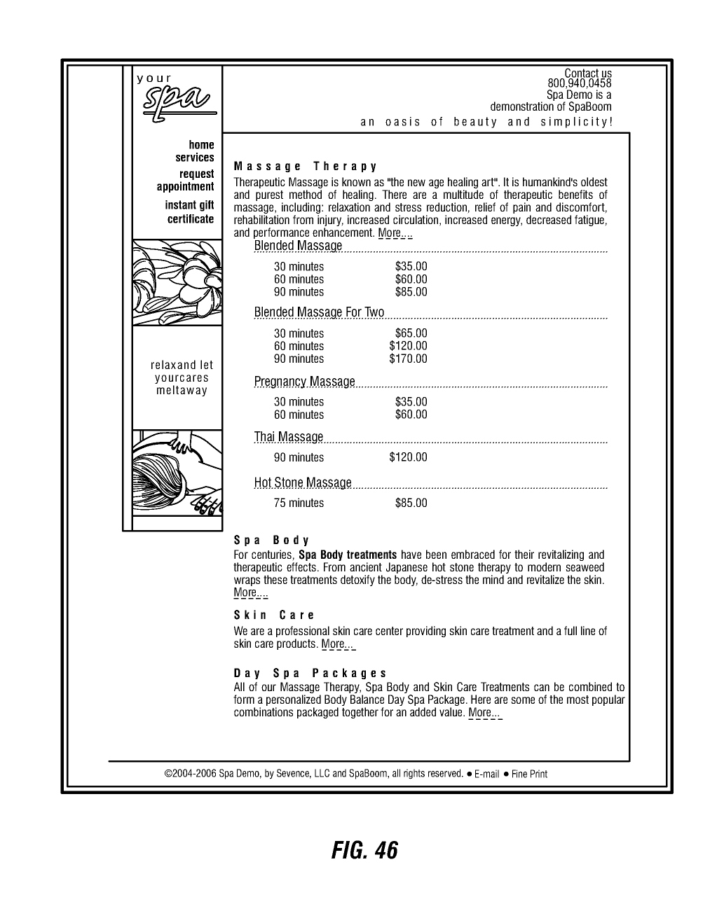

FIG. 46 also illustrates the services page of a personal services vendor's website. The difference between FIG. 45 and FIG. 46 is that the details of specific service offerings in the “Massage Therapy” category are presented. The specific service offerings are displayed because the “more” link associated with “Massage Therapy” has been selected.

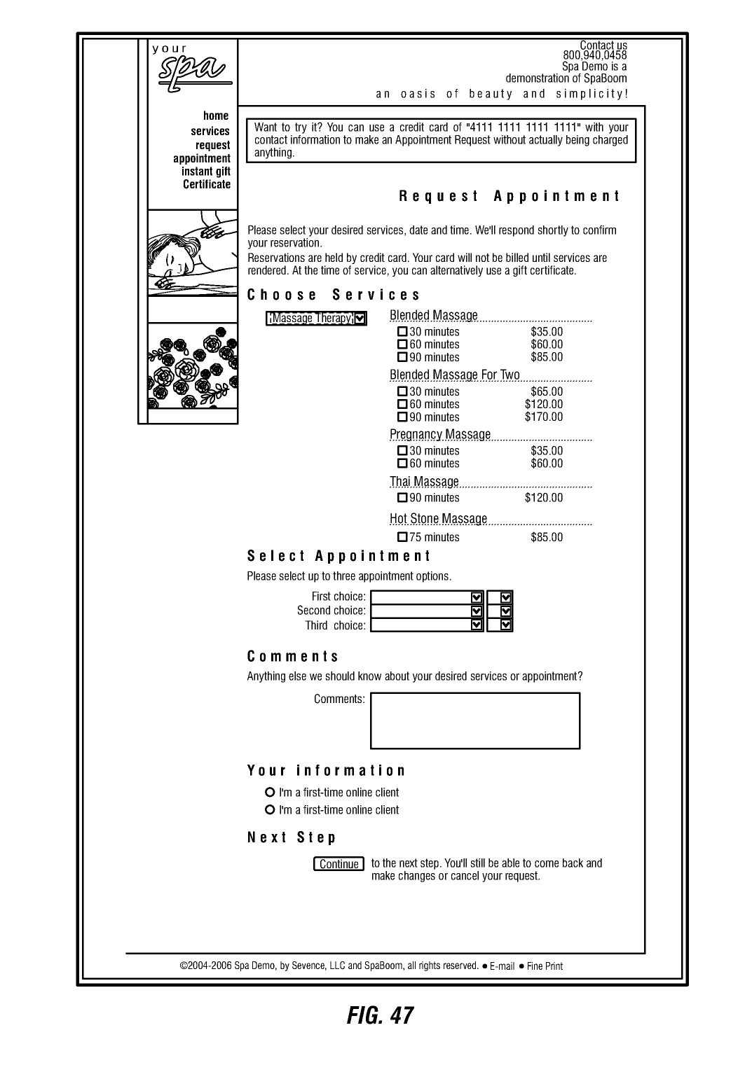

FIG. 47 illustrates the “Request Appointment” first page of a personal services vendor's website. Here, the service category can be selected from a menu. The services in the selected services category are displayed as options. An opportunity to select appointment times and supply comments is presented. A first time or returning client can make an appropriate selection before pressing the continue button.

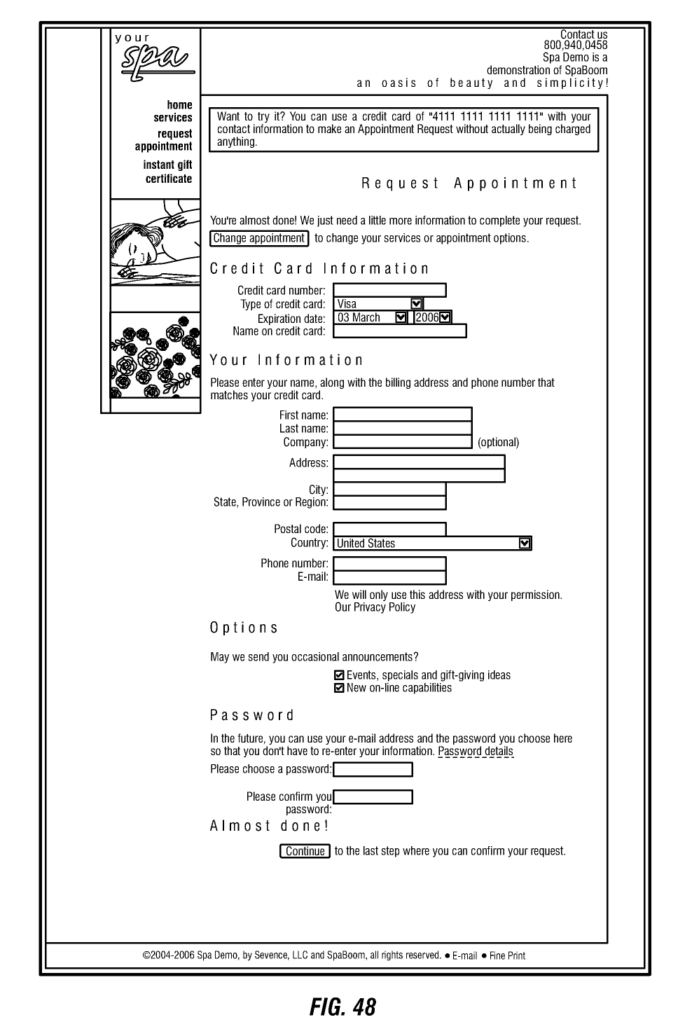

FIG. 48 illustrates the “Request Appointment” client information page of a personal services vendor's website. When “I'm a first time online client” is selected on the page illustrated in FIG. 47 and “continue” is selected, then the client is prompted for information that can be used to set up an account for that client. The client information can be stored in a client database.

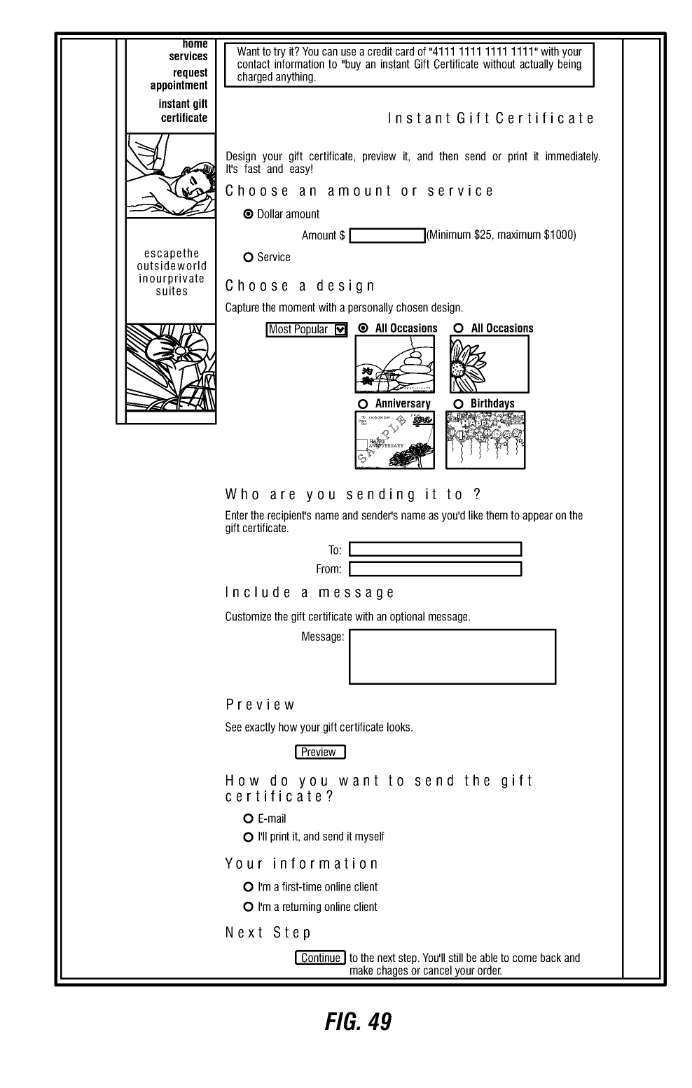

FIG. 49 illustrates the “Instant Gift Certificate” first page of a personal services vendor's website. A dollar amount or a service can be selected using radio buttons. Here, “Dollar amount” is selected. A customer can select the category of gift certificate design, as well as the particular design of interest. Considering the information of FIGS. 1-43, the remainder of the text is self explanatory. At the bottom of the page, the client is given two fulfillment options: email or print. The client can print out the gift certificate and then deliver it. Alternatively, an email containing the gift certificate can be automatically generated and electronically mailed to the gift recipient. Those practiced in the art of online fulfillment know of numerous ways to email a gift certificate. For example, an image file containing an electronic image of the gift certificate can be mailed. The gift buyer can receive a voided copy of the electronic gift certificate and a receipt.

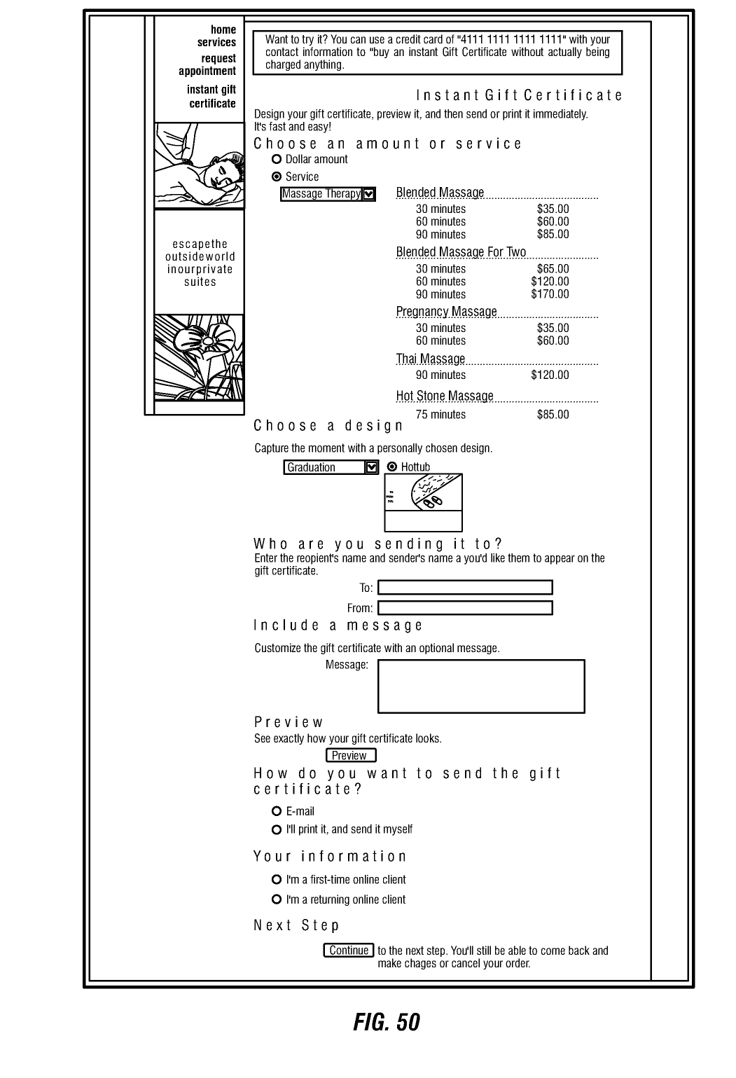

FIG. 50 illustrates the “Instant Gift Certificate” first page of a personal services vendor's website wherein the “Service” radio button is selected. As such, the service category menu and specific services, as previously discussed in relation to FIG. 47, is displayed.

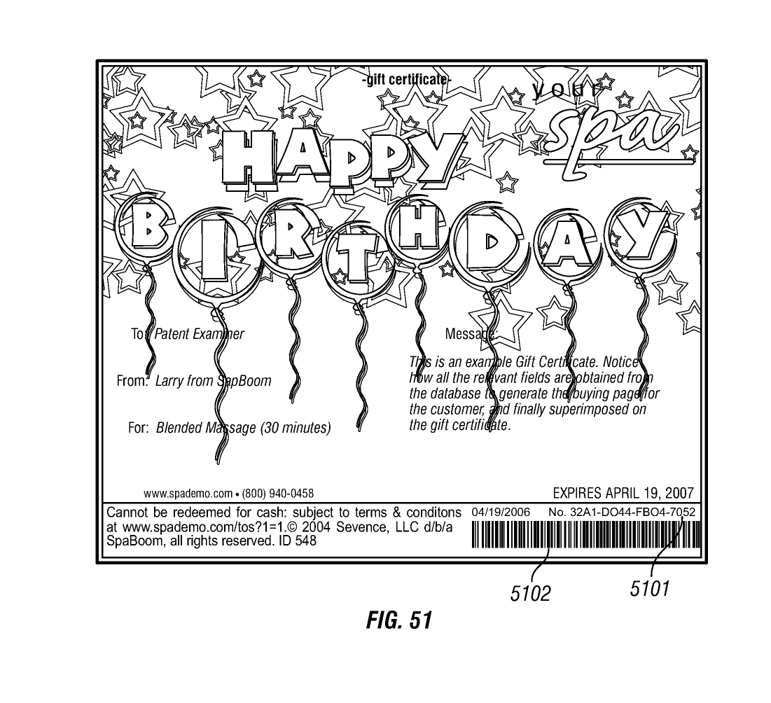

FIG. 51 illustrates the final product: an actual “Instant Gift Certificate” that a customer receives, once they have completed a purchase. The logo, website address and phone number of the relevant organization is superimposed on the image. The data fields required to form a valid gift certificate are also superimposed on the image. Those data fields include customized “To message”, “From message”, and “General message”, as well as, the amount of service, the expiration date, a security number 5101, bar code 5102, purchase date, reference to legal terms and conditions, and the gift certificate ID number. Notice that legal terms and conditions can be customized based on the organization's jurisdiction.

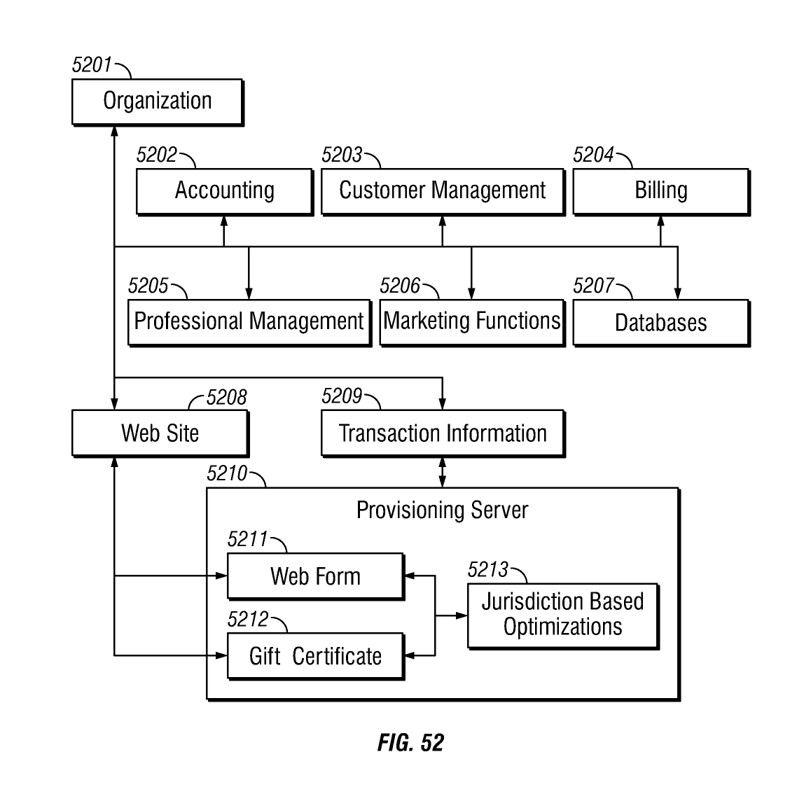

FIG. 52 illustrates a gift certificate service provider in accordance with aspects of certain embodiments. An organization 5201 makes provisions for accounting services 5202, customer management 5203, billing 5204, professional management 5205, marketing functions 5206, databases 5207, web site 5208, and gift certificates. The organization makes provisions for gift certificates by entering into a relationship with a gift certificate service provider.

The GC service provider maintains a GC provisioning server 5210 containing a jurisdiction based optimization module 5213. A client browsing an organization web site 5208 can choose to buy a gift certificate. The organization redirects the client's browsing session from the web site 5208 to a gift certificate page 5212 served by the provisioning server and provides transaction information to the provisioning server. FIG. 51 illustrates an example of a gift certificate page that has been customized to reflect the organization's identity. A jurisdiction based optimization module 5213 selects the terms and conditions to offer the client and to print on the gift certificate 5212.

The transaction information 5209 provided by the organization 5201 to the provisioning server 5210 contains, at a minimum, an organization identifier that the provisioning server 5210 can use to serve web pages associated with the organization 5201. The transaction information 5209 can also contain all the information needed for producing the gift certificate 5212. If all the required transaction information is not provided, the provisioning server 5210 can provide web forms 5211 for capturing client information. FIGS. 48-50 illustrate web forms that a provisioning server, or the organization, can use to obtain transaction information. Note that the web forms 5211 are customized to reflect the organization's brand. As such, the client does not perceive a substantive difference between the web site 5208 and the web pages served by the provisioning server 5210. The GC service provider can send a gift certificate 5212 to the client by fax, email, or physical mail. The client can also print the gift certificate 5212 directly from a web browser.

The GC service provider 5210 can obtain transaction information 5209 from the organization 5201, the organization web site 5208, or from another source. For example, the web site 5208 can embed the information in the URL passed to the GC service provider 5210, as is popular with server side scripting.

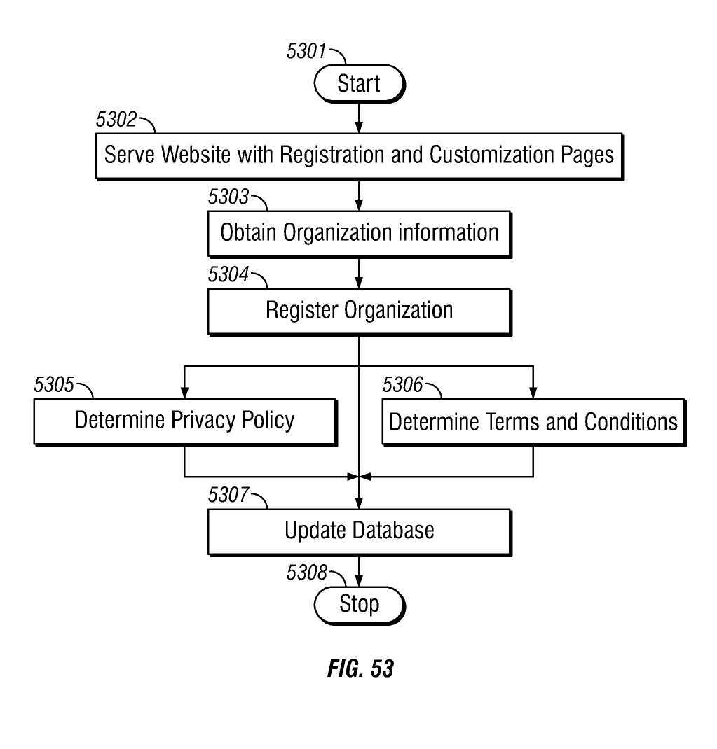

FIG. 53 illustrates a high level flow diagram of setting up an organization in accordance with aspects of the embodiments. After the start 5301, a web site is served that has registration and customization pages 5302. An organization can use the web site to provide information to the facilitator. After obtaining organization information 5303 the organization is registered. The types of information required for registration include the organization's jurisdiction that can be used to determine a customized privacy policy 5305 or customized terms and conditions 5306. The organization's information can be stored in a database 5307 before the process stops 5308.

As with the laws governing gift certificates, privacy laws can vary from states to state as well as having a federal component. As such, organizations in different jurisdictions can have different privacy policies. The organization can publish the privacy policy to its customers.

The terms and conditions need not be produced as part of the set up process. They can be produced during set up, however, if they are unlikely to change after the initial set up. If they are produced during set up, then a way is needed to update them due to changes in jurisdiction, law, or other factors. As such, some embodiments will determine terms and conditions during set up, others will produce them at other times.

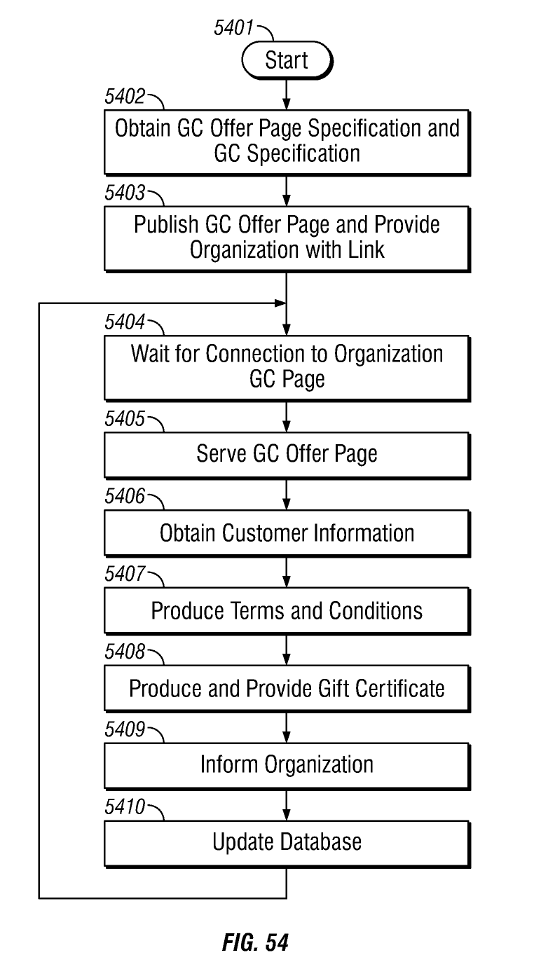

FIG. 54 illustrates a high level block diagram of providing an instant gift certificate ordering capability to an organization in accordance with aspects of certain embodiments. After the start 5401, instant gift certificate offer page specifications and instant gift certificate specifications are obtained 5402. The specifications specify the organization's design such as the background art, logo, font, and placement of text. The instant gift certificate offer page can then be published on a web server and the organization provided with a link to the page 5403. The organization can publish the link to its customers.

A connection to the instant gift certificate offer page is then waited for 5404 and the instant gift certificate offer page is served 5405 upon receiving a connection. Customer information is then obtained 5406, terms and conditions produced 5407, and a gift certificate produced and provided 5409 to the customer. The organization can be informed of the sale 5409 and the database updated with the sale information 5410. The process repeats to once again wait for a connection to the instant gift certificate offer page 5404.

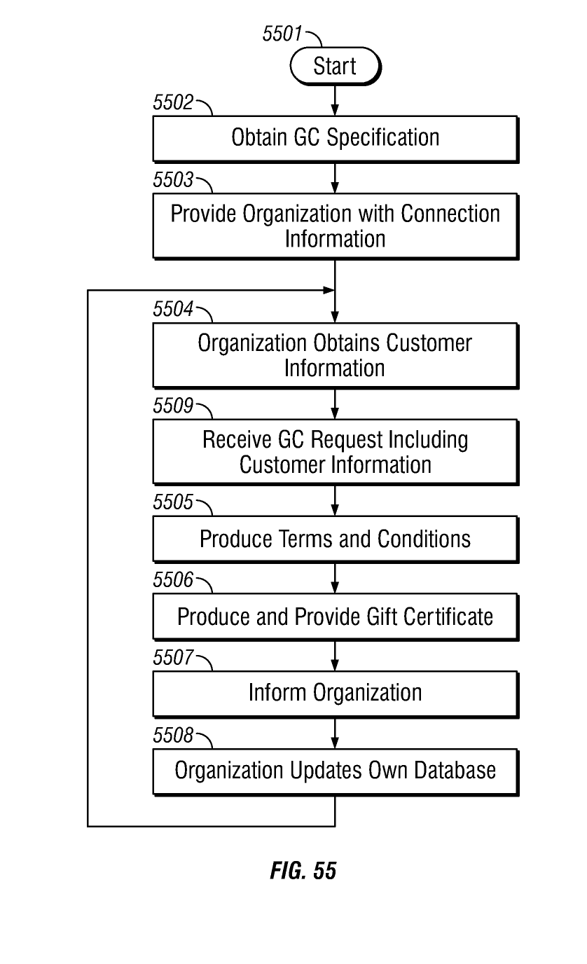

FIG. 55 illustrates a high level block diagram of receiving customer information from an organization and providing an instant gift certificate in accordance with aspects of certain embodiments. In this embodiment, the organization produces its own instant gift certificate offer page and sends customer information to the facilitator for instant gift certificate processing and fulfillment. After the start 5501 the instant gift certificate specification is obtained from the organization 5502 and the organization is provided with connection information 5503. The organization obtains customer information 5504 and, using the connection information, sends it in as part of an instant gift certificate request. The instant gift certificate request is received 5509 and processed. Terms and conditions can be produced 5505 and used when producing and providing the gift certificate 5506. A gift certificate can be provided by serving it as a graphic image or web page from a server. The organization is informed of the sale 5507 and updates its own database 5508. The instant gift certificate facilitator can also update its database. The process loops back to the point at which the organization obtains information from customers 5504.

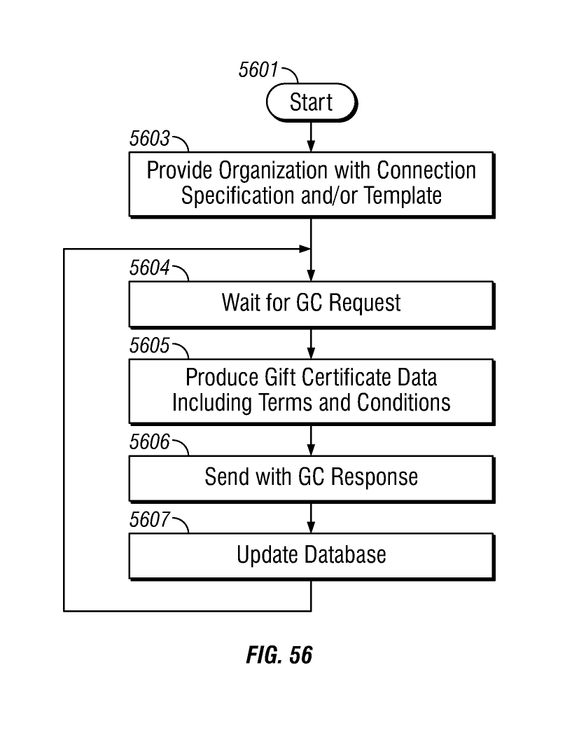

FIG. 56 illustrates a high level block diagram of receiving a gift certificate request and responding with gift certificate data in accordance with aspects of certain embodiments. After the start 5601, an organization is provided with a connection specification, with a template, or both 5603. A connection specification is a document telling the organization how to submit an instant gift certificate request and how to receive an instant gift certificate response. A template can be one or more computer programs or modules that instantiate the connection specification. The organization can simply install the template, perhaps with some modifications, into its own computer systems and then be certain of compliant communications with the instant gift certificate facilitator. Those practiced in the art of computer communications protocols are familiar with connection specifications and templates.

An instant gift certificate request is waited for 5604 and, when received, used to produce instant gift certificate data that includes terms and conditions 5605. The instant gift certificate data is then incorporated into an instant gift certificate response that is sent back to the organization 5606. The organization and/or the instant gift certificate facilitator can then update their databases with the sale information 5607.

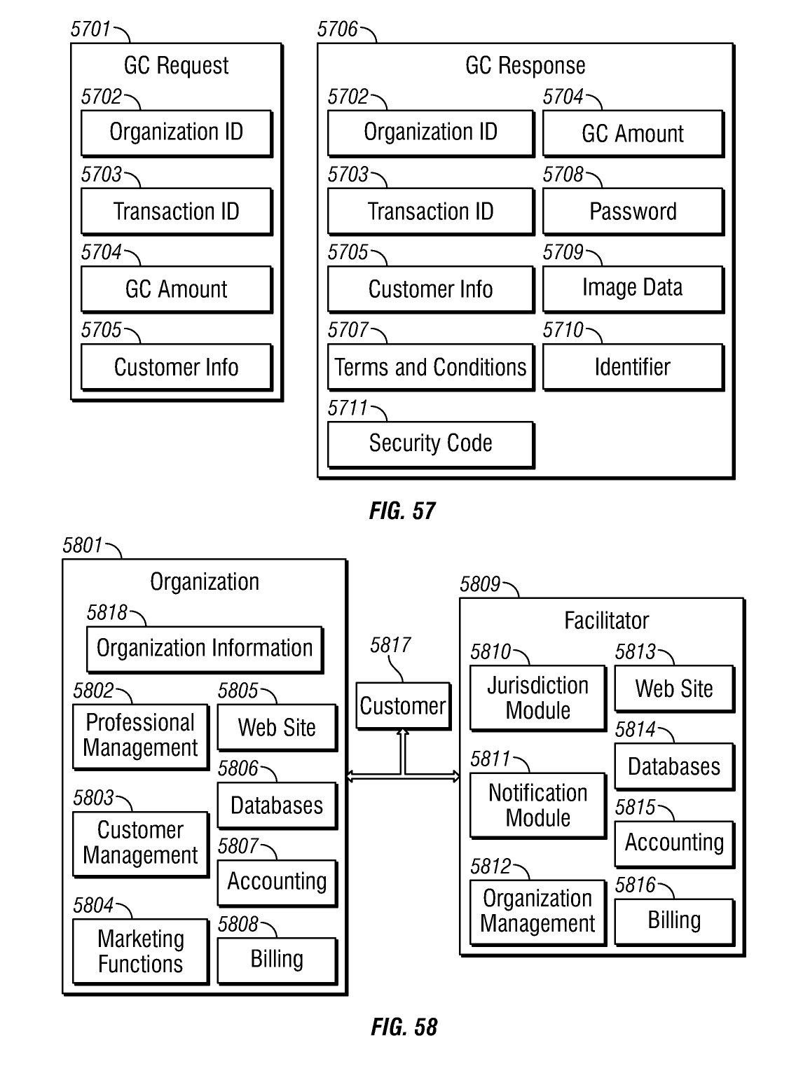

FIG. 57 illustrates high level block diagrams of a gift certificate request 5701 and a gift certificate response 5706 in accordance with aspects of certain embodiments. The gift certificate request can be an electronic message, such as an internet protocol packet, sent from an organization to a facilitator. The request 5701 can contain an organization Id 5702, transaction Id 5703, gift certificate amount 5704, and customer information 5705. An organization Id 5702 indicates which organization sent the request. A transaction Id 5703 can be used to identify specific transactions. A gift certificate amount 5704 indicates the monetary value of the gift certificate. Alternatively, a service can be specified such as “1 hour deep massage” instead of a monetary value. Customer information 5705 can contain details such as the customer's name, address, and billing information. Billing information is information such as billing address, and credit card number.

The gift certificate response 5706 can be an electronic message sent from a facilitator to an organization in response to a gift certificate request 5701. A gift certificate response 5706 can contain all the information contained in a gift certificate request 5701 as well as a password 5708, image data 5709, terms and conditions 5707, a gift certificate identifier 5710, and a security code 5711. A gift certificate identifier 5710 can be used for tracking a specific gift certificate. For example, the gift certificate identifier, as well as any other identifier or Id, can be used as an index key in the organization's databases and the facilitator's data bases. The terms and conditions 5707 can be customized based on the laws of the organization's legal jurisdiction, customer's legal jurisdiction, or both.

Image data 5709 can be an encoded image, such as a JPEG image, that can be used as part of the gift certificate. For example, the image data can encode a gift certificate's background art, a bar code or other graphic that in turn encodes gift certificate information, or even an image of the entire gift certificate.

A security code 5711 can be used to authenticate a gift certificate. Many ways of generating security code are known. For example, the data in the gift certificate response, other then security code, can be concatenated and submitted to a secure hash algorithm that in turn generates the security code 5711.

A password 5708 can be used to authenticate a gift certificate recipient (giftee). A password can be required from a giftee presenting a gift certificate to the organization. Alternatively, a customer can present themselves at an organization, such as a health spa, and supply a name and password such as “Megan” and “Happy Birthday”. As such, the giftee need not ever possess a physical gift certificate.

FIG. 58 illustrates a high level block diagram of entities involved in instant gift certificate transactions in accordance with aspects of the embodiments. An organization 5801 can be a business, such as a health spa or beauty salon that uses the facilitator 5809 in providing gift certificates to a customer 5817. The organization has a legal jurisdiction, meaning the jurisdiction whose laws govern the organization. Organization information 5818 can contain an address, the legal jurisdiction, and other data. The web site 5805 is the organization's 5801 virtual presence. Most organizations have databases that are used in support of billing 5808, accounting 5807, customer management 5803, marketing functions 5804, and professional management 5802. Professionals can be the organization's employees, subcontractors, associates, or affiliates.

A facilitator 5809 can have a web site 5813 for registering organizations, serving gift certificate offer pages, or presenting gift certificates. The databases can support accounting 5815, billing 5816, organization management 5812, the notification module 5811, and jurisdiction module 5810. The organization module can help facilitate interactions between the facilitator 5809 and any registered organizations. The notification module 5811 can be used to send messages to customers and giftees regarding gift certificate status and other matters. Billing 5816 can be used for the facilitator's own billing functions, such as billing an organization 5801 as well as for billing a customer 5817. Some organizations directly bill customers for gift certificates and use the facilitator for other functions such as order taking and presentment. Other organizations also use the facilitator for the gift certificate billing function.

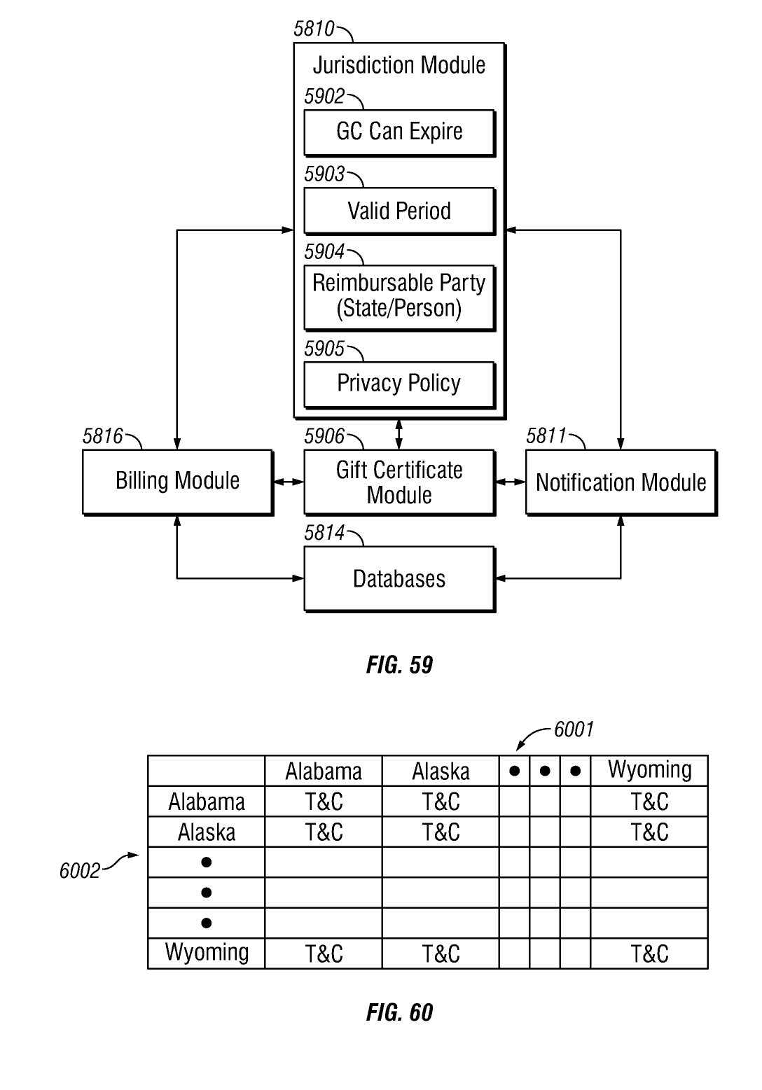

FIG. 59 illustrates a high level block diagram of modules that a facilitator can use in processing instant gift certificate transactions in accordance with aspects of the embodiments. The jurisdiction module 5810 contains information pertinent to the different jurisdictions to which the organizations and customers are subject. Some of the data indicates if a gift certificate can expire in the jurisdiction 5902, how long a gift certificate must be valid 5903, who to reimburse when a gift certificate expires 5904, and a jurisdiction compliant privacy policy 5905. The jurisdiction module 5810 can interact with the billing module 5816, gift certificate module 5906, notification module 5811, and other modules. The gift certificate module 5906 can obtain terms and conditions from the jurisdiction module 5810 and place them on a gift certificate as governed by a gift certificate specification.

FIG. 60 illustrates a table of terms and conditions in accordance with aspects of the embodiments. The top row 6001 labels the columns associated with organization jurisdictions. The leftmost row 6002 labels rows associated with customer jurisdictions. Each “T&C” cell contains customized terms and conditions that are specifically written for each combination of organization jurisdiction and customer jurisdiction. In some embodiments, the customer jurisdiction is ignored and the table collapses to a single row of terms and conditions. In other embodiments, the organization jurisdiction is ignored and the table collapses to a single column of terms and conditions. A jurisdiction module can use a table to look up the customized terms and conditions that should be placed on a gift certificate. The terms and conditions can be authored by a lawyer reviewing the laws of the various jurisdictions.

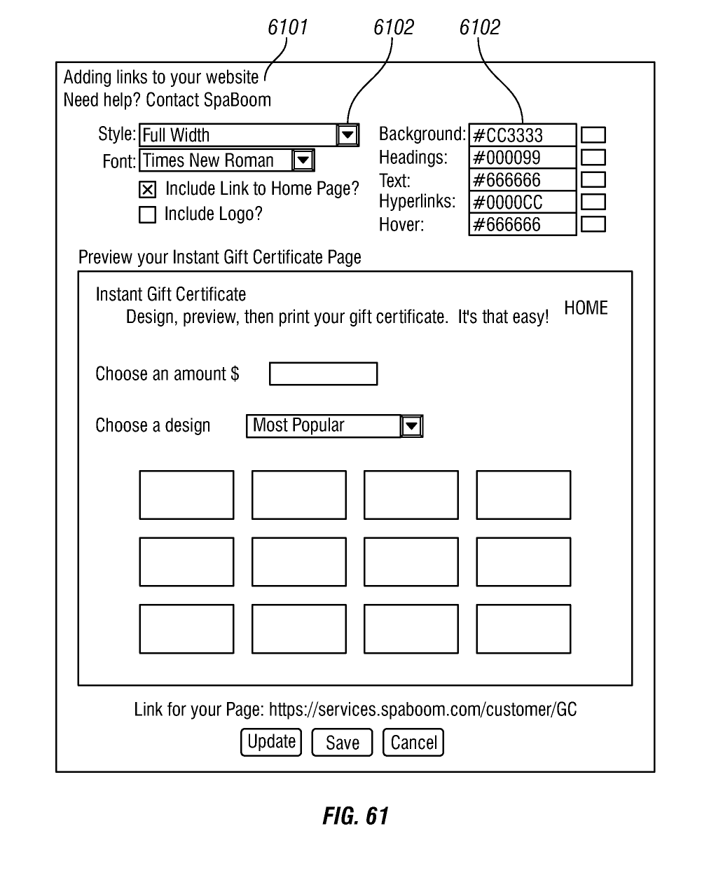

FIG. 61 illustrates a web page that a facilitator can serve to an organization for designing an instant gift certificate offer page in accordance with aspects of certain embodiments. Starting from the top of the page, there are two links 6101. The topmost link “Adding links to your website” can take a user to a page of directions for embedding links. “Contact SpaBoom” can take the user to a web form for sending questions and comments or can cause an email window to open that is already addressed to “SpaBoom”. Here, SpaBoom is the facilitator and the user is a person working on behalf of the organization that intends to use SpaBoom to facilitate the issuing of gift certificates.

Next, web page global settings 6102 can be set. “Style” and “Font” refer to text appearance. The right side specifies colors of well known web page elements. As is known to those practiced in the arts of web page design or computer graphics, a page “Background” can be set to a reddish “#CC3333” pixel value. A rectangle displaying a swatch of the selected color is positioned to the right of the pixel value.

Two selection boxes appear underneath the “Font” input. “Include Link to Home Page?” is checked and, as can be seen in the preview of the “Instant Gift Certificate” web page, a “HOME” link appears in the top left corner. No logo appears in the preview because “Include Logo” is not checked.

The instant gift certificate offer page that is being previewed is fairly simple. A customer can enter an amount and choose a design. Other gift certificate pages can include selections for a service, such as deep massage. The “Choose a design” drop down menu lets a customer select a category such as “Most Popular”, “Anniversary”, or “Valentines”. Three rows of four thumbnails of specific designs are shown under the “Choose a design” drop down menu. The specific thumbnails depend on the category.

A link to the instant gift certificate offer page appears under the preview. That is the link that the organization can place in its own web pages. A customer following the link is directed from the organizations web site to the “Instant Gift Certificate Page” hosted on the facilitator's web server. Alternatively, the facilitator can provide the web page to the organization in the form of computer files so that the organization can host the file itself.

Finally, there are three buttons at the bottom of the page. “Update” can cause the preview to be updated with the selected global settings 6102. “Save” can cause work to be saved such as when the user is done designing the page. “Cancel” can cancel the work done since the last “Save”.

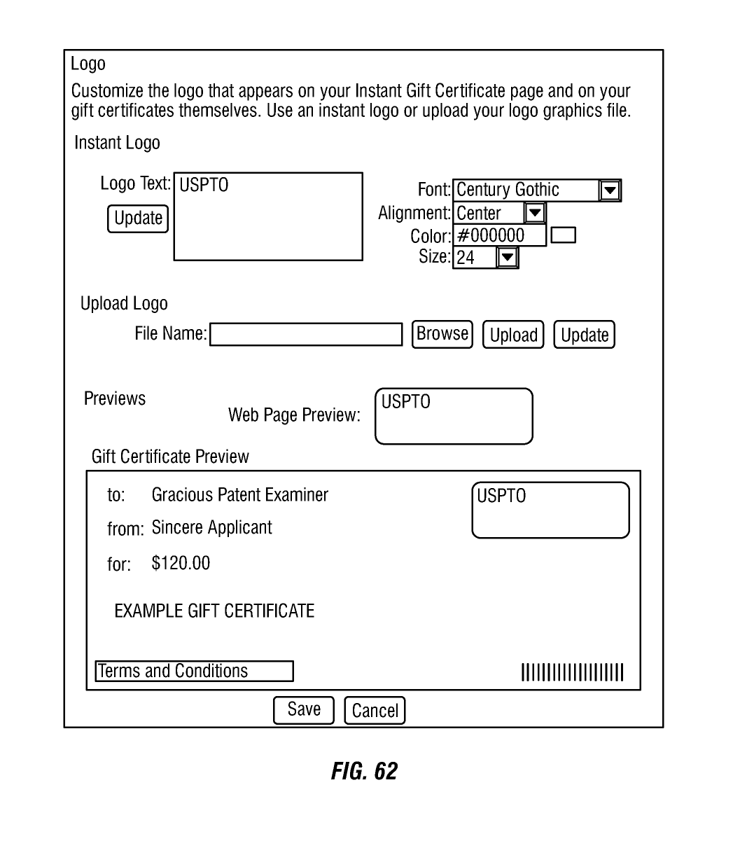

FIG. 62 illustrates a web page that a facilitator can serve to an organization for designing an instant logo and instant gift certificates in accordance with aspects of certain embodiments. An “Instant Logo” can be designed by entering text and choosing font, alignment, color and size. Here, a century gothic “USPTO” logo has been entered. Clicking the “Update” button can cause the logo to be presented in the previews. The web page preview shows how the logo would look if it were to appear on a web page such as on the “Instant Gift Certificate Page” of FIG. 61.

A graphic file containing a logo can be uploaded. Those practiced in the art of uploading files from web forms or attaching files to web based email are familiar with the mechanics of selecting a file and using the “Browse” and “Upload” buttons. Another “Update” button is used to cause the uploaded logo to appear in the previews.

The “Gift Certificate Preview” shows a user what an instant gift certificate might look like. In this example, the upper left corner contains “To:”, “From:” and “For:” fields. The logo appears in the upper right. The lower left corner presents customized terms and conditions that have been chosen based on the organization's legal jurisdiction. Different terms and conditions can be presented that are based on a customer's legal jurisdiction as well. The lower right corner presents a bar code. The bar code can encode information including a gift certificate Id, a security code, and other data such as that in the GC Response 5706 of FIG. 57. Clearly, data such as the gift certificate Id can be printed on a gift certificate outside of a bar code.

Finally, the “Save” and “Cancel” buttons can cause the designer's work to be saved or discarded. As with the “Instant Gift Certificate Page”, a gift certificate can be presented to a customer on a web page served by the organization or the facilitator.

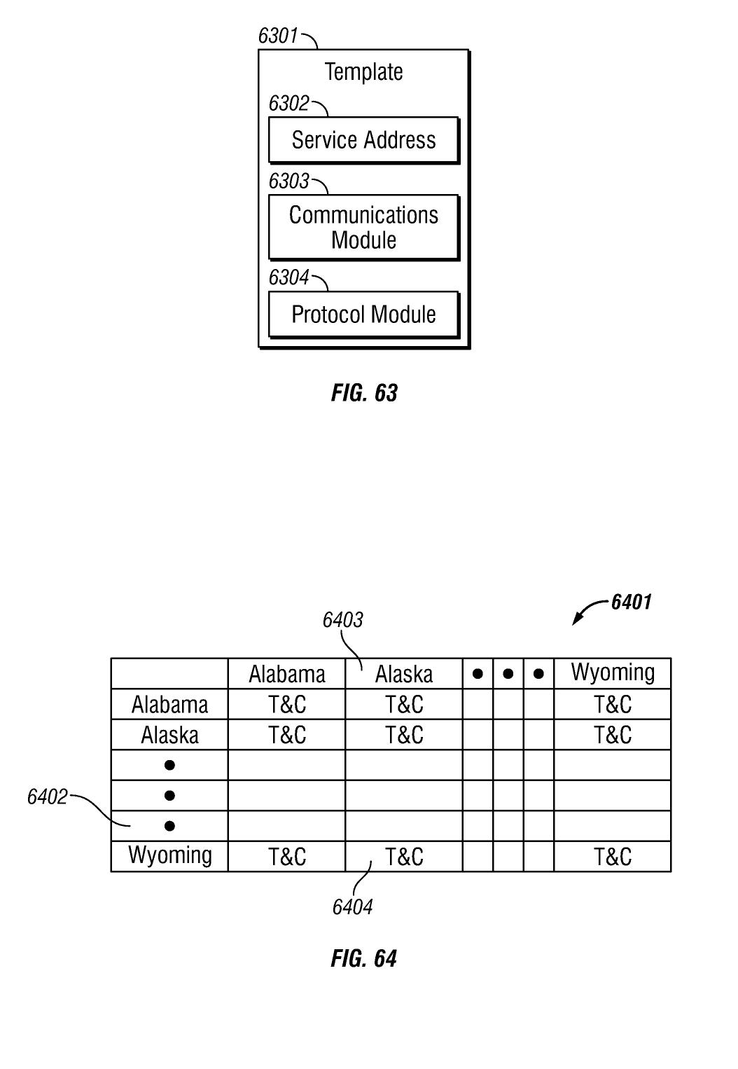

FIG. 63 illustrates a high level block diagram of a template 6301 that a facilitator can provide an organization for sending instant gift certificate requests and receiving instant gift certificate responses in accordance with aspects of certain embodiments. The illustrated template 6301 is an example of a template that can be used although there are doubtless many other template designs that can also, and equivalently, be used. The template 6301 contains a service address 6302, communications module 6303, and protocol module 6304. The service address can be the location on the internet to which requests can be sent and responses expected. For example, “request.spaboom.com:3030” specifies a host and a host port. A communications module 6303 can send and receive messages without understanding the content of the messages. The protocol module 6304 can understand the content of the message.

An example of using a template is that a facilitator provides an organization with a template. The template can be the same for all organizations or can be automatically customized for each organization. A customized template can provide the organization with a unique service address 6302 or other parameters that uniquely identify the organization to the facilitator.

When a customer attempts to purchase a gift certificate from the organization, the organization gathers the customer's information and uses the protocol module to form a gift certificate request. The communications module sends the request to the service address. The facilitator can process the request by billing the customer's credit card, producing a gift certificate Id and security code, and by entering the transaction in a database. The facilitator then sends a response.

Eventually, the communications module receives the response. The protocol module parses the response. One possibility is that the request was successfully processed. Another is that processing failed. The organization can react to the response by presenting an instant gift certificate or an error message.

The facilitator can send the proceeds from the gift certificate sale to organization immediately, aggregated daily, aggregated monthly, or by some other arrangement. The money can be transferred by written check, electronic funds transfer, or some other means.

FIG. 64 illustrates a jurisdiction based optimization table 6401 in accordance with aspects of certain embodiments. The rows 6402 correspond to the organization's jurisdiction while the columns 6403 correspond to the customer's jurisdiction. The cells 6404 provide terms and conditions based on the jurisdictions involved. Tables are notoriously well known data structures in the computing arts and as such the table of FIG. 64 can easily be instantiated as an algorithm. A jurisdiction based optimization module can use a table to select the terms and conditions applicable to a specific transaction.

Embodiments can be implemented in the context of modules. In the computer programming arts, a module (e.g., a software module) can be implemented as a collection of routines and data structures that perform particular tasks or implement a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term “module”, as utilized herein generally refers to software modules or implementations thereof. Such modules can be utilized separately or together to form a program product that can be implemented through signal-bearing media, including transmission media and recordable media.

The examples discussed above are intended to illustrate aspects of the embodiments. The phrases “an embodiment”, “some embodiments”, or “certain embodiments” do not necessarily refer to the same embodiment or any specific embodiment.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
providing a plurality of organizations with access to a management interface wherein the organizations submit management inputs through the management interface and wherein the management inputs comprise organization profile information;
providing the organizations with a plurality of organization web content sets that are initially based on a default web content set wherein each of the organization web content sets is associated with one of the organizations and wherein rendering the organization web content sets produces a plurality of customer interfaces that accept a plurality of customer inputs submitted by a plurality of customers;
offering to each organization a plurality of gift certificate types wherein the management inputs further comprise data for accepting at least one of the gift certificate types, and wherein each of the gift certificate types is branded for the organization to which the gift certificate type is offered by automatically incorporating some or all of the organization profile information, wherein accepting any one of the gift certificate types results in automatically creating a gift certificate offering and placing the gift certificate offering within the organization web content set associated with the organization to which the gift certificate type is offered;
accepting the customer inputs wherein the customer inputs comprise data for accepting a gift certificate offering that comprises recipient data specifying a recipient to receive a gift certificate; and
causing the gift certificate to be delivered to the customer or recipient.

2. The method of claim 1 further comprising:
providing each of the organizations with a services database wherein each organization provides a plurality of services to the customers wherein the services database comprises service data regarding the services and wherein the management inputs further comprise data for reading, writing, or modifying the service data.

3. The method of claim 1 further comprising:
providing each of the organizations with access to a customer database wherein the customer database comprises customer data regarding the customers wherein the management inputs further comprise data for reading, writing, or modifying the customer data, wherein the organization web content set comprises a customer interface that accepts customer inputs comprising customer input data for reading writing, or modifying the customer data.

4. The method of claim 1 wherein a web site that is branded for one of the organizations also presents content from the web content set associated with the one of the organizations.

5. The method of claim 1 wherein each organization is associated with one of a plurality of organization legal jurisdictions, wherein each customer is associated one of a plurality of customer legal jurisdictions, wherein each recipient is associated with one of a plurality of customer legal jurisdictions, wherein the gift certificate comprises a legal statement selected from a plurality of legal statements, and wherein the legal statement is selected based on the recipient legal jurisdiction, the customer legal jurisdiction, and the organization legal jurisdiction.

6. The method of claim 1 further comprising:
maintaining a customer database comprising customer data regarding the customers.

7. The method of claim 6 further comprising:
maintaining a customer database comprising customer data regarding the customers;
accepting promotion data from the organizations; and
distributing promotions to the customers.

8. The method of claim 1 further comprising maintaining a service database comprising service data regarding the services each of the organizations offers to the customers wherein the management inputs further comprise data for reading, writing, or modifying the service data.

9. The method of claim 1 further comprising:
providing the organizations with a plurality of organization web sites that are initially based on a default web site wherein each of the organization web sites is associated with one of the organizations, wherein the organization web sites comprise all or a portion of the organization web content set, and wherein the organizations are branded based on the organization profile information;
accepting further management inputs comprising data for customizing the organization web sites; and
hosting the organization web sites.

10. A method comprising:
accessing a facilitator web site provided by a facilitator;
submitting organization profile information to the facilitator web site such that the facilitator provides an organization web content set and a management interface and wherein the organization profile information comprises branding data;
selecting a gift certificate type from the management interface to thereby cause the organization web content set to automatically comprise a gift certificate offering wherein a customer accepting the gift certificate offering causes a gift certificate to be delivered to a customer or recipient, and wherein the gift certificate is automatically branded for the organization in accordance with the branding data; and
accepting and redeeming the gift certificate from the recipient.

11. The method of claim 10 further comprising providing personal services to the recipient.

12. The method of claim 10 further comprising submitting services data to the management interface such that the organization web content set further comprises a service offering.

13. The method of claim 10 further comprising accessing the management interface to alter the services data and thereby modify the service offering.

14. The method of claim 10 further comprising:
accepting payment data from the facilitator wherein the payment data is associated with the gift certificate; and
processing the payment data to thereby receive payment before the recipient redeems the gift certificate.

15. The method of claim 10 further comprising being subject to the laws of a jurisdiction wherein the organization data further comprises an indicator of the jurisdiction, wherein the gift certificate comprises a legal statement specific to the jurisdiction, and wherein the legal statement is automatically selected based on the indicator from a plurality of legal statements provided by the facilitator.

16. The method of claim 10 wherein the facilitator maintains a customer database comprising customer information regarding a plurality of organization customers.

17. The method of claim 16 further comprising providing promotion data to the management interface such that the facilitator distributes promotional material to the organization customers.

18. The method of claim 10 further comprising providing an outside web site wherein the outside web site presents at least a portion of the organization web content set to a customer.

19. A method comprising:
providing a plurality of organizations with access to a management interface wherein the organizations submit management inputs through the management interface;
providing the organizations with a plurality of organization web sites that are initially based on a default web site wherein each of the organization web sites is associated with one of the organizations and wherein the organization web sites are configured to accept a plurality of customer inputs submitted by a plurality of customers;
offering to each organization a plurality of gift certificate types wherein each of the gift certificate types is automatically branded for the organization to which the gift certificate type is offered, and wherein accepting any one of the gift certificate types results in a gift certificate offering within the web site associated with the organization to which the gift certificate type is offered;
providing each of the organizations with a services database wherein each organization provides a plurality of services to the customers wherein the services database comprises service data regarding the services;
accepting management inputs comprising:
data for reading, writing, or modifying the service data;
data for customizing the organization web sites to thereby brand the organization web sites for each of the organizations and to insert product offerings or service offerings into the organization web sites; and
data for accepting any of the gift certificate types;
hosting the organization web sites wherein at least one of the organization web sites comprises a gift certificate offering;
accepting the customer inputs wherein the customer inputs comprise data for accepting a gift certificate offering that comprises recipient data specifying a recipient to receive a gift certificate; and
causing the gift certificate to be delivered to the customer or recipient.

20. The method of claim 19 wherein each organization is associated with one of a plurality of organization legal jurisdictions, wherein each customer is associated one of a plurality of customer legal jurisdictions, wherein each recipient is associated one of a plurality of customer legal jurisdictions, wherein the gift certificate comprises a legal statement selected from a plurality of legal statements, and wherein the legal statement is selected based on the recipient legal jurisdiction, the customer legal jurisdiction, and the organization legal jurisdiction.

21. The method of claim 20 further comprising:
maintaining a customer database comprising customer data regarding the customers;
accepting promotion data from the organizations; and
distributing promotions to the customers.
